(19) United States
(12) Patent Application Publication
(10) Pub. No.: US 2026/0312734 A1
(43) Pub. Date: Oct. 8, 2026

(54) HYBRID AUTOMATIC REPEAT REQUEST (HARQ)-ACKNOWLEDGEMENT (ACK) CODEBOOK TYPE COMBINATIONS FOR HARQ-ACK CODEBOOK CONSTRUCTION AND TRANSMISSION IN LOOSE CARRIER AGGREGATION IMPLEMENTATIONS

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US)

(21) Appl. No.: 19/170,861

(22) Filed: Apr. 4, 2025

(51) Int. Cl. H04L 1/1822; H04W 72/1268; H04W 72/1273

(52) U.S. Cl. CPC H04L 1/1822; H04W 72/1268; H04W 72/1273

(57) ABSTRACT

Certain aspects of the present disclosure provide for hybrid automatic repeat request (HARQ)-acknowledgement (ACK) codebook construction and transmission. A method generally includes obtaining first signaling configuring the UE to use a first codebook type for a first cell group and second signaling configuring the UE to use a second codebook type for a second cell group; obtaining a first downlink control messages that schedule a first downlink data messages on first carrier(s) that are associated with the first cell group; obtaining a second downlink control messages that schedule second downlink data messages on second carrier(s) that are associated with the second cell group; and sending first feedback for the first downlink data messages that is multiplexed with second feedback for the second downlink data messages, wherein: the first feedback is formatted according to the first codebook type; and the second feedback is formatted according to the second codebook type.

### FIELD OF THE DISCLOSURE

Aspects of the present disclosure relate to wireless communications, and more particularly, to techniques for hybrid automatic repeat request (HARQ)-acknowledgement (ACK) codebook construction and transmission.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining first signaling that configures the UE to use a first codebook type for a first cell group; obtaining second signaling that configures the UE to use a second codebook type for a second cell group; obtaining a first plurality of downlink control messages that schedule a first plurality of downlink data messages on one or more first carriers that are associated with the first cell group; obtaining a second plurality of downlink control messages that schedule a second plurality of downlink data messages on one or more second carriers that are associated with the second cell group; and sending first feedback for the first plurality of downlink data messages that is multiplexed with second feedback for the second plurality of downlink data messages, wherein: the first feedback is formatted according to the first codebook type; and the second feedback is formatted according to the second codebook type.

Certain aspects provide a method for wireless communications by a network entity. The method includes sending first signaling that configures a UE to use a first codebook type for a first cell group; sending second signaling that configures the UE to use a second codebook type for a second cell group; sending a first plurality of downlink control messages that schedule a first plurality of downlink data messages on one or more first carriers that are associated with the first cell group; sending a second plurality of downlink control messages that schedule a second plurality of downlink data messages on one or more second carriers that are associated with the second cell group; and obtaining first feedback for the first plurality of downlink data messages that is multiplexed with second feedback for the second plurality of downlink data messages, wherein: the first feedback is formatted according to the first codebook type; and the second feedback is formatted according to the second codebook type.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts examples of carrier aggregation.

FIG. 6 depicts example uplink control information (UCI) construction and transmission for carrier aggregation with two physical uplink control channel (PUCCH) groups.

FIG. 7 depicts example semi-static hybrid automatic repeat request (HARQ)-acknowledgement (ACK) codebook-based feedback generation.

FIG. 8 depicts example dynamic HARQ-ACK codebook-based feedback generation.

FIG. 9 depicts example HARQ-ACK codebook construction and transmission in a loose carrier aggregation implementation.

FIG. 10 depicts a process flow for communications in a network between a network entity and a UE for HARQ-ACK codebook construction and transmission in a loose carrier aggregation implementation.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for hybrid automatic repeat request (HARQ)-acknowledgement (ACK) codebook construction and transmission in loose carrier aggregation implementations. As described herein, a loose carrier aggregation implementation may may allow for the configuration of two distinct “cell groups” of component carriers (CCs) configured for use by a user equipment (UE), such that HARQ-ACK codebook construction is performed separately and independently for each cell group. However, each HARQ-ACK codebook constructed for each cell group may be combined into a single codebook for transmission (e.g., to a network entity). In certain aspects, different HARQ-ACK codebook types for the distinct cell groups may be used. As such, different HARQ-ACK codebook type combinations configured for the distinct cell groups may be considered herein.

Transmissions over wireless communications channels (e.g., such as a physical downlink shared channel (PDSCH), a physical uplink shared channel (PUSCH), etc.) are often subject to errors, at least due to non-ideal channel characteristics (e.g., such as noise, fading, interference, etc.) of such channels causing variations in signal quality. For example, a receiver may encounter an error when attempting to decode a signal that has been transmitted to the receiver over a wireless communications channel. One technique for mitigating errors in wireless communications is an automatic repeat request (ARQ), by which a receiver requests a re-transmission of a transmitted signal associated with an error. Another technique for mitigating errors in wireless communications is error correction, or channel coding, by which redundancy is systematically added to a transmitted signal through, for example, various coding schemes. The redundancy introduced by the coding scheme(s) may help a receiver of the transmitted signal to detect error(s) and, in some cases, correct them without needing to request re-transmission.

Some wireless communication technologies have adopted a combination of ARQ and error correction referred to as HARQ. Specifically, HARQ combines error correction and automatic repeat requests, allowing a receiver to request re-transmission of lost or corrupted data packets (e.g., a data packet is a formatted unit of data communicated over a network, generally including a header and a payload).

As an illustrative example, prior to transmission, a transmitter may apply an error correcting code (e.g., such as turbo codes, low-density parity-check (LDPC), etc.) to data intended for a receiver. This encoding may add redundancy (e.g., redundant bits) to the data, allowing a receiver to detect and correct errors that may occur during transmission. The encoded data may form a data packet that is transmitted over a wireless communications channel to the receiver. In some cases, the receiver may decode the received data and transmit an ACK to the transmitter confirming that the transmitted data packet was received successfully and without errors. The ACK may serve as feedback to the transmitter, indicating that the transmitter may proceed with transmitting a next data packet, as this data packet has been successfully received and decoded. In some other cases, one or more errors may occur during transmission, and the receiver may attempt to correct the error using the redundant bits (e.g., added based on the error correcting code). The receiver may transmit an ACK to the transmitter if the error is able to be corrected and the receiver is able to successfully decode the received data. Otherwise, the receiver may transmit a negative acknowledgement (NACK) (or not transmit an ACK) indicating that the transmitted data packet was not received successfully and contains errors that could not be corrected. The NACK or lack of ACK may serve as feedback to the transmitter indicating that the particular data packet needs to be re-transmitted. Upon receiving the NACK or a time after not receiving an ACK, the transmitter may re-transmit the data to the receiver. Further, in some other cases, the receiver may fail to detect and receive the data packet. As such, the data packet may be lost, and the receiver may transmit a NACK or not transmit an ACK indicating that the transmitted data packet was not received successfully. The NACK of lack of ACK may prompt the transmitter to re-transmit the data. As illustrated by this example, HARQ may help to enhance communication reliability, especially in noisy and/or unstable communication environments.

In some cases, such as in a carrier aggregation scenario, a receiver may need to provide HARQ-ACK feedback for multiple data packets at a same time (e.g., simultaneously). As used herein, the phrase “HARQ-ACK feedback” may refer to ACK feedback only, NACK feedback only, or ACK feedback and NACK feedback associated with one or more data packets. Further, “carrier aggregation” in wireless communication may refer to the simultaneous use of multiple CCs for communicating with a single device, such as to effectively enable higher data rates and/or improve spectrum utilization. A “CC” may include, and/or may be referred to as, a “carrier” (e.g., a specific frequency band or radio frequency) used for wireless communications in a particular cell (e.g., a portion, partition, or segment of wireless communication coverage served by a device, such as a network entity).

For example, in some cases, a receiver may receive, from one or more transmitters, data on multiple CCs (e.g., two or more CCs) at the same time (e.g., enabling a higher data rate at the receiver). The transmitter may be a network entity, and the receiver may be a UE that is capable of carrier aggregation. Each CC may operate independently; thus, the UE may need to provide HARQ-ACK feedback for each data transmission (e.g., data packet) on each CC separately, thereby resulting in multiple ACK(s) and/or NACK(s) being sent from the UE to the network entity. The network entity may use the HARQ-ACK feedback, associated with each CC, to determine which data transmission(s), if any, need to be re-transmitted to the UE.

In certain aspects, the UE may send the HARQ-ACK feedback associated with each CC (e.g., of the multiple CCs) as a separate transmission. For example, different physical uplink control channel (PUCCH) resources may be allocated to each CC to enable the UE to independently provide uplink control information (UCI), including HARQ-ACK feedback, to the network entity for each CC that is used for communicating a data packet between the UE and the network entity.

In certain other aspects, such as to improve signaling overhead and efficiency, multiple CCs and their allocated PUCCH resources may be grouped together to form a “PUCCH group.” The PUCCH group may enable the UE to send UCI, including HARQ-ACK feedback, associated with each CC in the PUCCH group as a single uplink transmission (e.g., via a PUCCH) to the network entity (e.g., even in cases where the CCs of the PUCCH group are non-contiguous). For example, a PUCCH group may include five CCs, which are used for communicating data between the network entity and the UE. The PUCCH resources associated with each of the five CCs may be combined and used for the communication of a single transmission indicating HARQ-ACK feedback for each CC in the PUCCH group. In certain aspects, the single transmission may be sent via a CC that is designated as a “primary carrier” (e.g., used for communicating in a primary cell (PCell), which refers to a cell where the UE initially connects to the network) of the PUCCH group.

In certain aspects, HARQ-ACK feedback associated with each CC in the PUCCH group (e.g., multiple ACK(s) and/or NACK(s)) may be multiplexed into the single uplink transmission and formatted according to a HARQ-ACK codebook. Specifically, a HARQ-ACK codebook is a format for a sequence of bits to simultaneously signal multiple ACK(s) and/or NACK(s) to a transmitter, such as a network entity. A HARQ-ACK codebook may allow a receiver, such as the UE, to multiplex ACK(s) and/or NACK(s) from multiple slots, carriers, transport blocks (TBs), and/or code block groups (CBGs) within a single PUCCH or PUSCH transmission. The Third Generation Partnership Project (3GPP) specification defines three types of HARQ-ACK codebooks including (1) a type I HARQ-ACK codebook (simply referred to herein as “type I” or “type 1”), (2) a type II HARQ-ACK codebook (simply referred to herein as “type II” or “type 2”), and (3) a type III HARQ-ACK codebook (simply referred to herein as “type III” or “type 3”). HARQ-ACK codebook types I, II, and III may differentiate based on their dynamic nature, with type I being a static codebook, type II being dynamic and adapting to a number of downlink (e.g., PDSCH) transmissions requiring feedback, and type 3 being a “one-shot” codebook used for situations where only a single feedback is needed, generally resulting in lower overhead but potentially less flexibility.

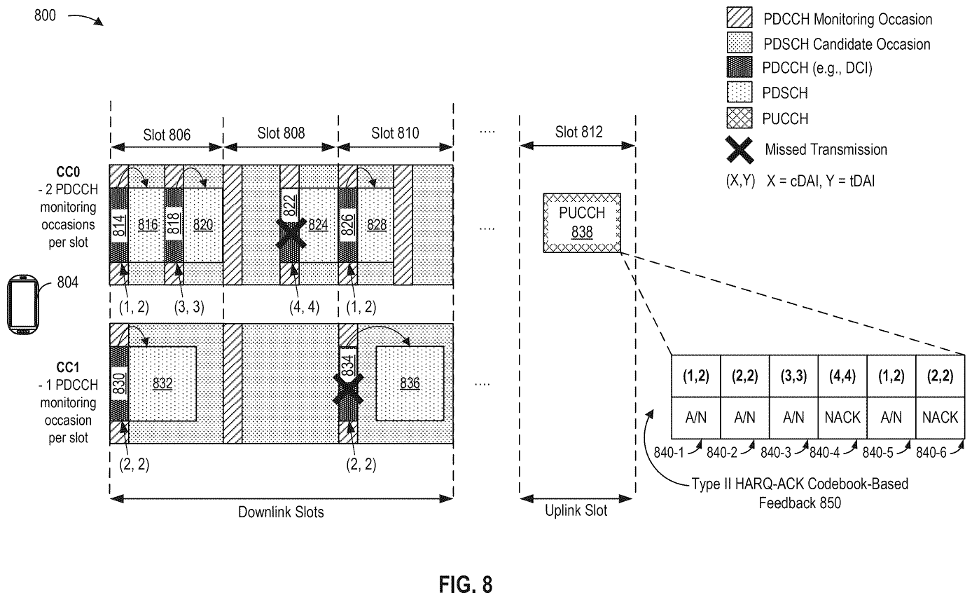

Technical problems associated with generating a single codebook for multiple CCs (e.g., of a PUCCH group) in carrier aggregation may include increased complexity in implementation, as well as, in some cases, increased signaling overhead and inefficiency in UCI transmission. For example, multiplexing control information for a large number of CCs belonging to a same PUCCH group may result in larger and/or more frequent transmissions of UCI. In some cases, this may lead to increased signaling overhead and/or the potential overload of a CC used for sending the multiplexed transmissions. Further, combining UCI for multiple CCs may require tight coordination at the network. That is, a network entity may be responsible for ensuring that HARQ-ACK feedback for each CC is properly encoded into a single codebook such that the feedback is clear and correctly associated with a corresponding downlink transmission of a data packet (e.g., for efficient and accurate interpretation by the network entity). For example, in some cases where the HARQ-ACK feedback is to be formatted according to the type II HARQ-ACK codebook, a central scheduler may be implemented at a network entity to coordinate the timing of downlink transmissions, as well as the information (e.g., such as a counter downlink assignment index (DAI) (cDAI) or a total DAI (tDAI), described in detail below, at least with respect to FIG. 8) included in such downlink transmissions, such that HARQ-ACK feedback for these transmissions may be properly combined in a single codebook for transmission (e.g., an amount and/or layout of such feedback in the codebook is accurate). Without this coordination, errors in providing HARQ-ACK feedback may occur, which may, in some cases, result in degraded performance of the wireless communications network.

In an effort to mitigate the aforementioned technical problems, some approaches may allow for the configuration of two PUCCH groups, where (1) first control information (e.g., including HARQ-ACK feedback) associated with a first subset of the CCs (e.g., belonging to a first PUCCH group) is transmitted in the uplink via a CC (e.g., a primary carrier) of the first subset of CCs and (2) second control information (e.g., including HARQ-ACK feedback) associated with a second subset of the CCs (e.g., belonging to a second PUCCH group) is transmitted in the uplink via a CC (e.g., a secondary carrier) of the second subset of CCs. Put differently, separate HARQ-ACK codebook construction and transmission may be enabled for the two PUCCH groups. Although the construction of separate codebooks for each PUCCH group may help to reduce the need for tight coordination at a network entity, additional coordination, via the network entity, may be needed to help achieve synchronization between the uplink transmissions of the different PUCCH groups (e.g., thereby increasing the complexity of the network entity). Further, the configuration of two PUCCH groups for separate HARQ-ACK codebook construction and transmission may not be preferred for a cell-edge UE, at least due to poor coverage of the cell for a higher frequency band and/or or due to simultaneous transmission at the UE, such as when power is shared.

Certain aspects described herein overcome the aforementioned technical problems associated with providing HARQ-ACK feedback in carrier aggregation scenarios and provide a technical benefit to the field of telecommunications. For example, certain aspects provide techniques for HARQ-ACK codebook construction and transmission using a “loose” carrier aggregation implementation (e.g., setup).

The loose carrier aggregation implementation described herein may allow for the configuration of two distinct “cell groups” of CCs (similar to the configuration of two PUCCH groups of CCs), such that codebook construction (e.g., generation) is performed separately and independently for each cell group. Separate and independent codebook construction among the cell groups may permit loose coordination between the cell groups, thereby removing any need for a central scheduler to coordinate the timing of downlink transmissions, as well as the information included in such downlink transmission, communicated via CCs of each cell group for reducing errors in the HARQ-ACK feedback.

Further, the loose carrier aggregation implementation described herein may facilitate the combination of HARQ-ACK codebook-based feedback for each cell group in a single uplink transmission. For example, in certain aspects, HARQ-ACK codebook-based feedback constructed for the first cell group may be multiplexed with HARQ-ACK codebook-based feedback constructed for the second cell group and sent as a single codebook for transmission. In certain aspects, the HARQ-ACK codebook-based feedback for the two cell groups may be multiplexed and sent to a network entity via a PUCCH scheduled in a PCell of the first cell group. In certain aspects, the HARQ-ACK codebook-based feedback for the two cell groups may be multiplexed and sent to the network entity via a PUSCH scheduled in the PCell of the first cell group. Further, in certain aspects, the HARQ-ACK codebook-based feedback for the two cell groups may be multiplexed and sent to the network entity via a PUSCH scheduled in a secondary cell (SCell) of the second cell group (e.g., an SCell is an additional cell, beyond the PCell, that may be used for data transmission).

In certain aspects, separate codebook construction among the cell groups may be configured based on the separate configuration of HARQ-ACK codebook types for each cell group. For example, in certain aspects, a UE may obtain first signaling configuring the UE to use a first codebook type for the first cell group and second signaling configuring the UE to use a second codebook type for the second cell group.

Various codebook type combinations may be considered and configured for the first cell group and the second cell group. For example, in a first option, the UE may be configured to format HARQ-ACK feedback for the first cell group according to the type II HARQ-ACK codebook and format HARQ-ACK feedback for the second cell group according to the type I HARQ-ACK codebook (e.g., type 1+type 2). In a second option, the UE may be configured to format HARQ-ACK feedback for the first cell group according to the type II HARQ-ACK codebook and format HARQ-ACK feedback for the second cell group according to the type III HARQ-ACK codebook (e.g., type 2+type 3). In a third option, the UE may be configured to format HARQ-ACK feedback for the first cell group according to the type I HARQ-ACK codebook and format HARQ-ACK feedback for the second cell group according to the type III HARQ-ACK codebook (e.g., type 1+type 3). In a fourth option, the UE may be configured to format HARQ-ACK feedback for the first cell group according to the type III HARQ-ACK codebook and format HARQ-ACK feedback for the second cell group according to the type I HARQ-ACK codebook (e.g., type 3+type 1). In a fifth option, the UE may be configured to format HARQ-ACK feedback for the first cell group according to the type III HARQ-ACK codebook and format HARQ-ACK feedback for the second cell group according to the type III HARQ-ACK codebook (e.g., type 3+type 3).

Certain aspects described herein may avoid configuring a UE to use the type II HARQ-ACK codebook when constructing HARQ-ACK feedback for the second cell group (e.g., type 1/2/3+type 2 may not be configured). Specifically, as described herein, the size of a type II HARQ-ACK codebook for the second cell group may dynamically change based on a number of PDSCH transmissions that are scheduled to be transmitted to a UE using CCs of the second cell group. Due to the loose coordination between the cell groups, the first cell group may not be aware of the size of the HARQ-ACK codebook-based feedback constructed for the second cell group when the feedback is formatted according to the type II HARQ-ACK codebook. Thus, the first cell group may assume a maximum payload size for scheduling the uplink transmission used to communicate the HARQ-ACK codebook-based feedback from both the first and second cell groups. Assuming the maximum payload size may, in some cases, result in a waste of resources and/or increase signaling overhead in the wireless communication network. Further, knowledge of the true payload size may be needed by a network entity receiving the uplink transmission including the HARQ-ACK feedback for both cell groups. Thus, configuring the UE to use the type II HARQ-ACK codebook when generating HARQ-ACK feedback for the second cell group (e.g., type 1/2/3+type 2) may not be feasible.

Different codebook type combinations configured for the two cell groups may necessitate different DCI field(s) and/or information included in DCIs scheduling downlink data messages (e.g., for which HARQ-ACK feedback is provided) and/or uplink data messages in each of the cell groups. The different DCI field(s) and/or information of DCIs used when different codebook type combinations are configured for the distinct cell groups are described in detail below.

Certain techniques for HARQ-ACK codebook construction and transmission described herein may provide various beneficial technical effects and/or advantages. The techniques for HARQ-ACK codebook construction and transmission may enable improved wireless communications performance, such as reduced signaling overhead, reduced complexity, and increased accuracy in HARQ-ACK codebook-based feedback generation. The reduced signaling overhead may be attributable to the use of a single uplink transmission for communicating HARQ-ACK feedback for multiple CCs belonging to two cell groups. The reduced complexity may be attributable to the separate and independent codebook construction among cell groups, thereby helping to reduce the need for coordination among the cell groups. The increased accuracy in HARQ-ACK codebook-based feedback generation may also be attributable to the separate and independent codebook construction among cell groups. For example, separate DAI counting across cell groups may be enabled, reducing the likelihood of errors in DAI counting for codebook construction.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

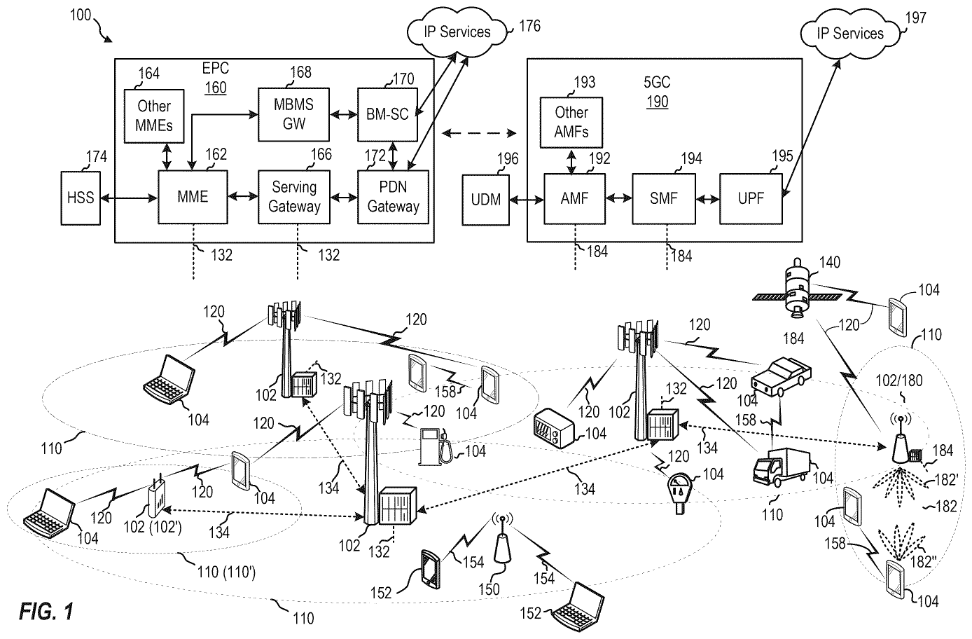

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

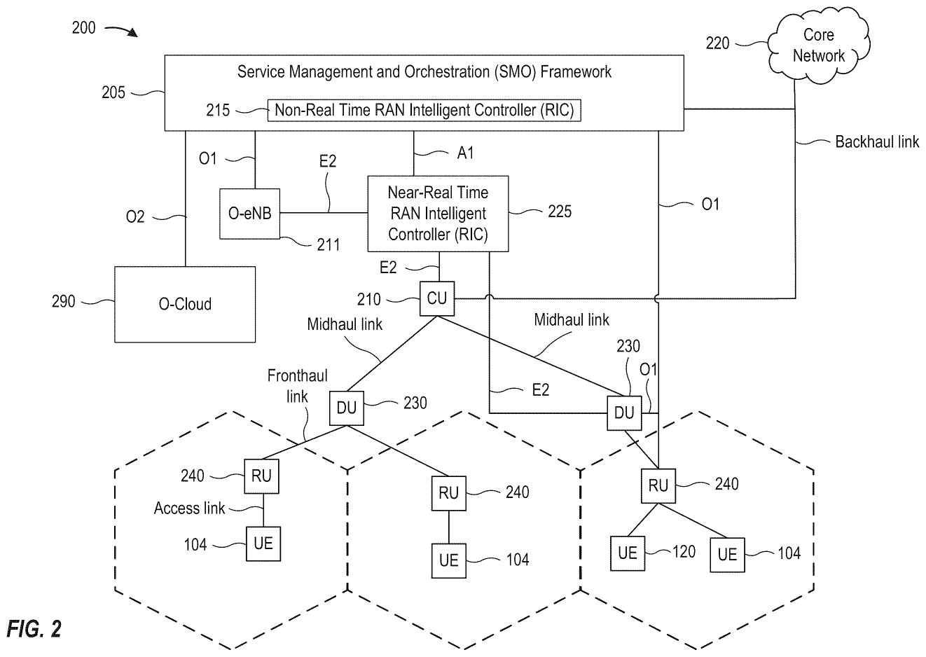

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the 3GPP currently defines Frequency Range 1 (FR1) as including 410 MHz 7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

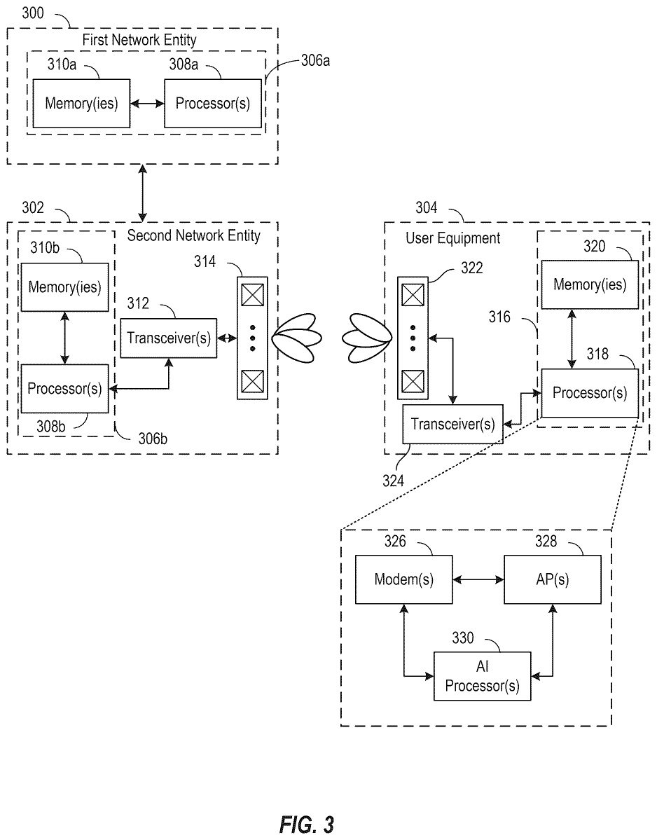

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

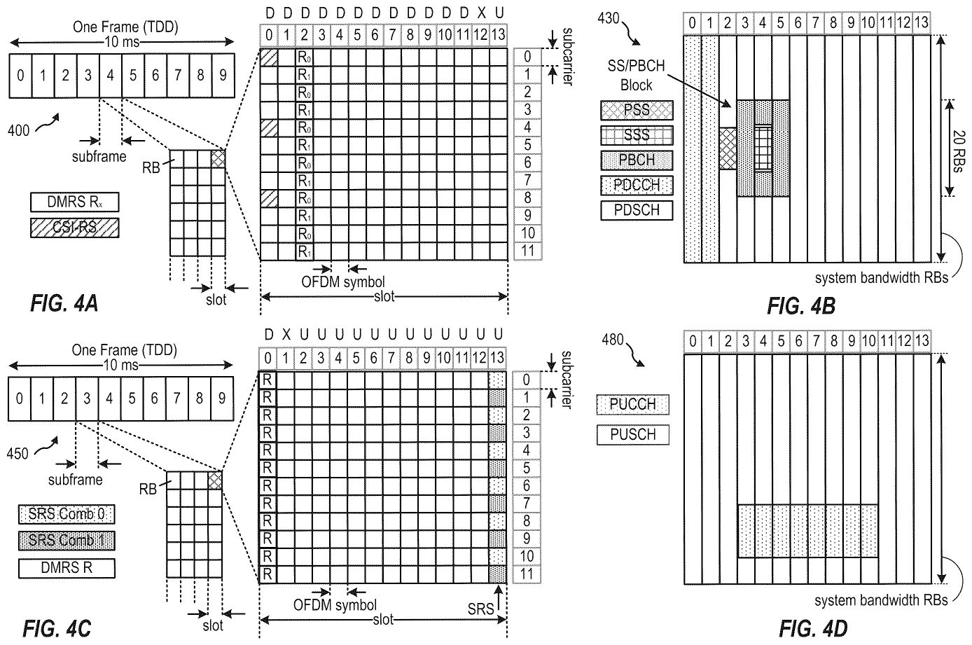

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ-ACK/NACK feedback. The PUSCH carries data, and may additionally be used to carry a buffer status report (BSR), a power headroom report (PHR), and/or UCI.

### Example Carrier Aggregation

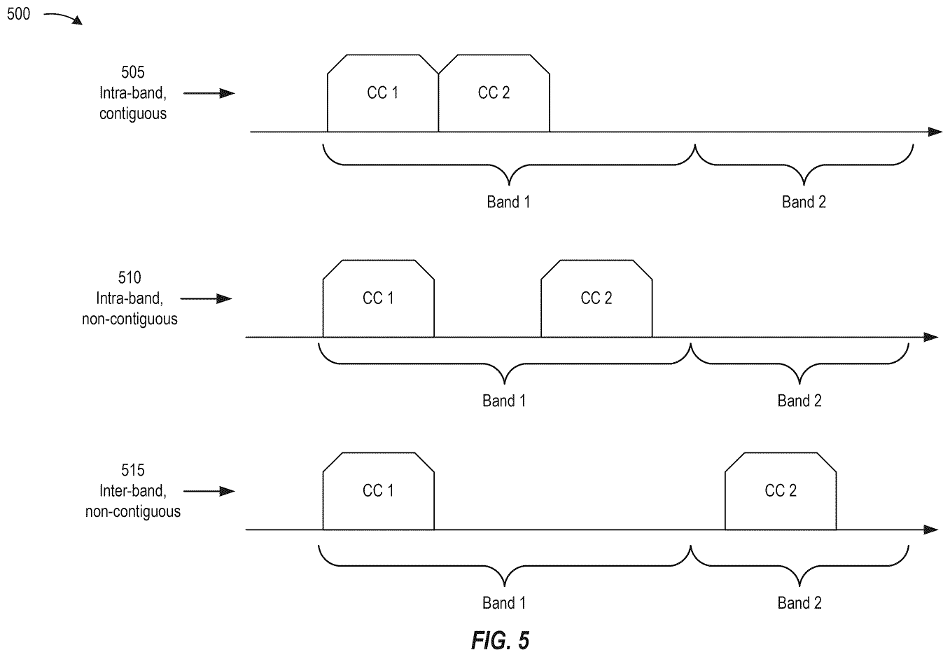

FIG. 5 is a diagram illustrating examples 500 of carrier aggregation.

Carrier aggregation is a technology that enables two or more CCs to be combined (e.g., into a single channel) for a single UE (e.g., such as UE 104 of FIG. 1 or UE 304 of FIG. 3) to enhance data capacity. A “CC” may include, and/or may be referred to as, a “carrier.” For example, “CC” and “carrier” may be used interchangeably herein. As shown in FIG. 5, CCs may be combined in the same or different frequency bands. Additionally, or alternatively, contiguous or non-contiguous carriers may be combined. A network entity (e.g., such as BS 102 of FIG. 1, a first network entity 300 or second network entity 302 of FIG. 3, or a disaggregated base station as discussed with respect to FIG. 2) may configure carrier aggregation for a UE, such as in a radio resource control (RRC) message, a DCI message, and/or the like.

As shown by reference number 505, in certain aspects, carrier aggregation may be configured in an intra-band contiguous mode where the aggregated CCs (e.g., CC1 and CC2) are contiguous to one another and are in the same band. As shown by reference number 510, in certain aspects, carrier aggregation may be configured in an intra-band non-contiguous mode where the aggregated CCs (e.g., CC1 and CC2) are non-contiguous to one another and are in the same band. In certain aspects, aggregated CC in the same band (e.g., contiguous and non-contiguous) may use the same subcarrier spacing (SCS). As shown by reference number 515, in certain aspects, carrier aggregation may be configured in an inter-band non-contiguous mode where the aggregated CCs (e.g., CC1 and CC2) are non-contiguous to one another and are in different bands. In certain aspects, aggregated CCs in different bands may use different SCS.

In carrier aggregation, a UE may be configured with a primary CC (a “primary carrier”) and one or more secondary CCs (“secondary carrier(s)”). A primary CC may be used for communication to/from the UE in a primary cell (PCell) (e.g., the primary CC may correspond to the PCell). Further, a secondary CC may be used for communication to/from the UE in a secondary cell (SCell) (e.g., the secondary CC may correspond to the specific SCell). In certain aspects, the primary CC may carry control information (e.g., DCI, scheduling information, and/or the like) for scheduling data communications on one or more secondary CC, which may be referred to as “cross-carrier scheduling.” In certain aspects, a CC (e.g., a primary CC or a secondary CC) may carry control information for scheduling data communications on the CC, which may be referred to as “self-carrier scheduling” or “carrier self-scheduling.”

As indicated above, FIG. 5 is provided as an example. Other examples may differ from what is described with regard to FIG. 5.

### Example Pucch Grouping

Some wireless communications networks (e.g., such as wireless communications network 100 of FIG. 1) may support PUCCH grouping, where multiple CCs configured for a UE, and their allocated PUCCH resources, are grouped into one or two PUCCH groups.

For example, one or more PUCCH resources may be allocated to a CC that is configured for use by the UE, such as to enable the UE to transmit, to a network entity, UCI for the CC. In certain aspects, the UCI communicated using the CC may include HARQ-ACK feedback for a data packet communicated between the UE and a network entity in a cell corresponding to the CC.

A PUCCH group may combine the PUCCH resources allocated to two or more CCs configured for the UE, such that UCI associated with the different CCs can be combined in a single PUCCH transmission. Put differently, when a PUCCH group is defined for two or more CCs, UCI from all CCs in the PUCCH group may be sent as a single transmission, rather than as multiple separate UCI transmissions for each CC. Thus, PUCCH grouping techniques may beneficially help to reduce the signaling overhead associated with control signaling in carrier aggregation scenarios.

As an illustrative example, a UE may be configured to communicate with a network entity using four CCs. A first CC of the four CCs, referred to as a “primary CC,” may be used by the UE to communicate with the network entity in a PCell. The remaining three CCs, each referred to as a “secondary CC,” may be used by the UE to communicate with the network entity in three SCells. Different PUCCH resources may be allocated to each CC to enable the UE to independently provide, to the network entity, UCI for each CC. In some cases, the PUCCH resources allocated to the four CCs may be combined, thereby forming a single PUCCH group for the four CCs, such that UCI for the four CCs may be multiplexed and sent as a single transmission to the network entity.

In certain aspects, CCs configured for use by a UE may be combined, along with their allocated PUCCH resources, to form a single PUCCH group. Alternatively, in certain aspects, (1) a first subset of CCs configured for use by a UE may be combined, along with their allocated PUCCH resources, to form a first PUCCH group and (2) a second subset of CCs configured for use by a UE may be combined, along with their allocated PUCCH resources, to form a second PUCCH group. The first subset of CCs may include the primary CC and one or more secondary CCs configured for the UE. The second subset of CCs may include one or more other secondary CCs configured for the UE. In this case, two uplink transmissions may be used to communicate UCI for the multiple CCs. For example, UCI associated with the first subset of CCs may be multiplexed and transmitted, to a network entity, as a first uplink transmission (e.g., a first PUCCH transmission) in the PCell. Further, UCI associated with the second subset of CCs may be multiplexed and transmitted, to the network entity, as a second uplink transmission (e.g., a PUCCH transmission) in an SCell associated with one of the secondary CCs in the second set of CCs.

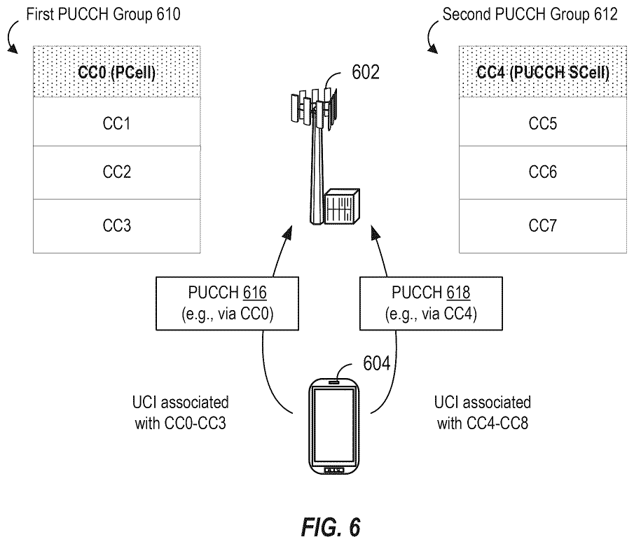

FIG. 6 depicts example UCI construction and transmission for carrier aggregation with two PUCCH groups. As shown in FIG. 6, a UE 604 (e.g., such as UE 104 of FIG. 1 or UE 304 of FIG. 3) may be configured with eight CCs (e.g., CC0 through CC7) for communicating with a network entity 602 (e.g., such as BS 102 of FIG. 1, a first network entity 300 or second network entity 302 of FIG. 3, or a disaggregated base station as discussed with respect to FIG. 2). CC0 may be referred as a “primary CC” of UE 604, which may be used by UE 604 to communicate with network entity 602 in a PCell. CC1, CC2, CC3, CC4, CC5, CC6, and CC7 may each be referred to as a “secondary CC” of UE 604, which may be used by UE 604 to communicate with network entity 602 in a respective SCell (e.g., CC1 is used to communicate with network entity 602 in a first SCell, CC2 is used to communicate with network entity 602 in a second SCell, etc.).

A first subset of the CCs configured for use by UE 604, including CC0, CC1, CC2, and CC3, may be combined, along with their allocated PUCCH resources, to form a first PUCCH group 610. Further, a second subset of the CCs configured for use by UE 604, including CC4, CC5, CC6, and CC7, may be combined, along with their allocated PUCCH resources, to form a second PUCCH group 612.

Combined PUCCH resources associated with CC0, CC1, CC2, and CC3 may be used to send, to network entity 602, control information associated with CC0, CC1, CC2, and CC3. For example, UCI associated with each of CC0, CC1, CC2, and CC3 may be multiplexed and transmitted, to network entity 602, as a single uplink control transmission (e.g., PUCCH 616). CC0 (e.g., the primary CC) may be used to send PUCCH 616 to network entity 602 in the PCell associated with CC0.

Similarly, combined PUCCH resources associated with CC4, CC5, CC6, and CC7 may be used to send, to network entity 602, control information associated with CC4, CC5, CC6, and CC7. For example, UCI associated with each of CC4, CC5, CC6, and CC7 may be multiplexed and transmitted, to network entity 602, as another single uplink control transmission (e.g., PUCCH 618). CC4 (e.g., a secondary CC) may be used to send PUCCH 618 to network entity 602 in the SCell associated with CC0.

In certain aspects, as described in detail below, PUCCH 616 may carry HARQ-ACK feedback associated with downlink transmissions in cells associated with CC0, CC1, CC2, and CC3. Similarly, PUCCH 618 may carry HARQ-ACK feedback associated with downlink transmissions in cells associated with CC4, CC5, CC6, and CC7.

### Example HARQ-ACK Codebooks

Wireless communications may be unreliable at times. Techniques, such as HARQ, may help to recover transmission errors by allowing an intended receiver of a transmitted data packet to indicate, to a transmitter of the transmitted data packet, whether the transmitted data packet was received and decoded successfully. As described herein, the receiver (1) may transmit an ACK when the receiver receives and is able to correctly decode the received data, and (2) may transmit a NACK when the receiver does not receive and/or is unable to correctly decode the data. A NACK may prompt the transmitter to re-transmit the data, with the hope that the re-transmitted data may be successfully received and correctly decoded at the receiver.

In some cases, a receiver may need to provide HARQ-ACK feedback (e.g., ACKs and/or NACKs) for multiple data packets at a same time (e.g., simultaneously). The receiver may transmit such HARQ-ACK feedback according to a HARQ-ACK codebook. Specifically, a HARQ-ACK codebook is a format for a sequence of bits to simultaneously signal multiple HARQ-ACKs and/or NACKs to a transmitter. A HARQ-ACK codebook may allow a receiver to multiplex HARQ-ACKs and/or NACKs from multiple slots, carriers, TBs, and/or code block groups (CBGs) within a single PUCCH or PUSCH transmission.

As described herein, the 3GPP specification defines three types of HARQ-ACK codebooks including (1) a type I HARQ-ACK codebook, (2) a type II HARQ-ACK codebook, and (3) a type III HARQ-ACK codebook. HARQ-ACK codebook types I, II, and III may differentiate based on their dynamic nature, with type I being a semi-static codebook, type II being dynamic and adapting to a number of downlink (e.g., PDSCH) transmissions requiring feedback, and type 3 being a “one-shot” codebook used for situations where only a single feedback is needed, generally resulting in lower overhead but potentially less flexibility.

For example, the size of the type-1 HARQ-ACK codebook may be fixed based on a number of PDSCH candidate occasions (e.g., corresponding to time and frequency resources where PDSCH transmissions may be scheduled by a network entity and monitored for by a UE) that occur during a particular time window (e.g., a “K1 window”), irrespective of whether or not PDSCH is scheduled in each of these PDSCH candidate occasions or not. Put differently, for the type-1 HARQ-ACK codebook, HARQ-ACK feedback (e.g., ACK feedback or NACK feedback) may be included for each and every PDSCH candidate occasion where PDSCH may potentially be scheduled. As such, the codebook may include ACK/NACK feedback for all PDSCH candidate occasions occurring during the time window irrespective of whether or not any downlink data is actually transmitted in these occasions.

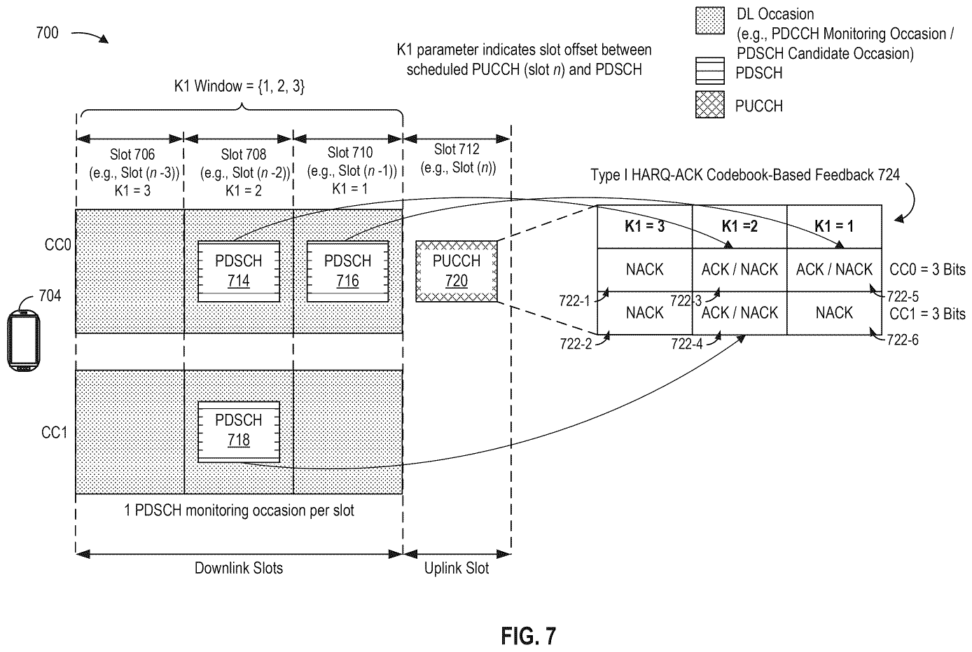

FIG. 7 depicts example type I (e.g., semi-static) HARQ-ACK codebook-based feedback generation 700. As shown in FIG. 7, a UE 704 (e.g., such as UE 104 of FIG. 1 or UE 304 of FIG. 3) may be configured to use two CCs, CC0 and CC1, for communication with a network entity (not shown in FIG. 7). More specifically, downlink data message(s) (e.g., PDSCH transmission(s)) may be scheduled in slot 706 (e.g., slot (n-3)), slot 708 (e.g., slot (n-2)), and slot 710 (e.g., slot (n-1)), via one or more downlink control messages. Additionally, uplink control message(s) (e.g., PUCCH transmission(s)) may be scheduled in slot 712 (e.g., slot (n)) via one or more downlink control messages. CC0 and CC1 may be used to transmit, from the network entity to UE 704, scheduled PDSCH transmission(s) in slots 706, 708, and 710. Further, CC0 may be used to transmit, from UE 704 to the network entity, scheduled PUCCH transmission(s) in slot 712. Because PDSCH transmission(s) may be scheduled in three slots (e.g., slots 706, 708, and 710) and two CCs are used for communication, six PDSCH candidate occasions may be used by (1) the network entity for PDSCH transmission(s) and (2) the UE for monitoring for the PDSCH transmission(s).

As mentioned above, HARQ-ACK feedback generated for a type I HARQ-ACK codebook may include ACK or NACK feedback for each PDSCH candidate occasion within a K1 window, regardless of whether or not a PDSCH transmission is scheduled in each PDSCH candidate occasion in the K1 window. In this example, the K1 window is equal to {1, 2, 3} indicating that a type I HARQ-ACK codebook constructed by UE 704 may include ACK and/or NACK feedback for each of the six PDSCH candidate occasions occurring during the K1 window, regardless of whether or not PDSCH transmissions (e.g., downlink data messages) are scheduled in each of these six PDSCH candidate occasions. Put differently, the codebook may have a fixed size and include ACK and/or NACK feedback corresponding to six PDSCH candidate occasions.

In this example, a PDSCH 714 may be scheduled in slot 708 for communication via CC0, a PDSCH 716 may be scheduled in slot 710 for communication via CC0, and a PDSCH 718 may be scheduled in slot 708 for communication via CC1. Thus, CC0 may transmit, from the network entity to the UE 704, PDSCH 714 and PDSCH 716 in slots 708 and 710, respectively. Further, CC1 may transmit, from the network entity to the UE 704, PDSCH 718 in slot 708.

The type I HARQ-ACK codebook-based feedback 724 (simply “feedback 724”), constructed by UE 704 for the K1 window, may include six entries 722-1 through 722-6. Entries 722-1 and 722-2 may be associated with slot 706. Because no PDSCH transmissions are scheduled, via CC0 and CC1, in slot 706, each of the entries 722-1 and 722-2 may include 1-bit “NACK” feedback. Entries 722-3 and 722-4 may be associated with slot 708. Because PDSCH transmissions are scheduled, via CC0 and CC1, in slot 708, each of the entries 722-3 and 722-4 may include 1-bit “ACK” or “NACK” feedback. Entries 722-5 and 722-6 may be associated with slot 710. Because a PDSCH transmission is scheduled, via CC0, in slot 710, entry 722-5 may include 1-bit “ACK” or “NACK” feedback. Further, because no PDSCH transmission is scheduled, via CC1, in slot 710, entry 722-6 may include 1-bit “NACK” feedback. Thus, the feedback 724 may include a total of 6 bits for transmission.

In this example, UE 704 may transmit, to the network entity, the feedback 724 via an uplink control message (e.g., PUCCH 720) scheduled in slot 712 using CC0. Specifically, CC0 may be used to transmit the feedback 724 to the network entity in a PCell associated with CC0.

One drawback of the type I HARQ-ACK codebook is the potentially large size of the codebook. For example, in scenarios where UE 604 is configured with a small number of CCs, this may be less of a problem. However, if a large number of CCs are configured for use by UE 604, and only a small number of them are simultaneously scheduled for communicating downlink data to UE 604, then the number of bits included in the codebook may be very high although only a few of the bits may be useful to the network entity for identifying whether re-transmission(s) are warranted.

To address the drawback of a potentially large type I (e.g., semi-static) HARQ-ACK codebook in some scenarios, 3GPP also supports the use of the type II (e.g., dynamic) HARQ-ACK codebook. The underlying principle of the type II (e.g., dynamic) HARQ-ACK codebook is to report HARQ-ACK feedback (e.g., including ACK/NACK bits) only for TBs (e.g., data packets) that have been actually scheduled and sent by a network entity to a UE, such as to help decrease the size of the codebook (e.g., when compared to the codebook size of a type I HARQ-ACK codebook) for signaling overhead reduction.

The type II HARQ-ACK codebook may help to reduce the size of the codebook for transmission by excluding codebook entries that correspond to unused PDSCH transmission opportunities. Put differently, the type II HARQ-ACK codebook may not include any bits for PDSCH candidate occasions where no PDSCH transmission is scheduled. However, a technical challenge associated with the use of this type II HARQ-ACK codebook involves maintaining an understanding of relationships between entries included in the codebook and downlink transmissions that are actually scheduled to be sent to the UE. For example, when using the type I HARQ-ACK (e.g., semi-static) codebook, there exists a one-to-one mapping between each entry in the codebook and each PDSCH candidate occasion (e.g., where a downlink data message may be scheduled and sent). Thus, if a UE misses a downlink control message (e.g., DCI) scheduling a PDSCH transmission in a PDSCH candidate occasion, the UE may still populate the type I HARQ-ACK (e.g., semi-static) codebook with “NACK” feedback for the PDSCH candidate occasion. Accordingly, the missed downlink control message may not affect the information that is included in the codebook.

For the type II HARQ-ACK codebook, however, the missed downlink control message may cause the network entity and the UE to have different understandings related to a number PDSCH transmissions that have been scheduled for the UE (e.g., on one or more carriers), which may lead to an incorrect codebook size generated by the UE. Further, in some cases, this misunderstanding may corrupt the HARQ-ACK feedback included in the codebook for multiple CCs, including CCs for which downlink control signaling was not missed.

As an illustrative example, a first downlink control message may be sent, by a network entity to a UE, to schedule a first PDSCH transmission, intended for the UE, in a first slot. Further, a second downlink control message may be sent, by the network entity to the UE, to schedule a second PDSCH transmission, also intended for the UE, in a second slot. The UE may miss the first downlink control message scheduling the first PDSCH transmission. Thus, the UE may be unaware of the scheduled first PDSCH transmission and include only ACK/NACK feedback for the second PDSCH transmission in a type II HARQ-ACK codebook generated to include ACK and NACK feedback for at least the two PDSCH transmissions. The UE may transmit, to the network entity, the codebook including only the ACK/NACK feedback for the second PDSCH transmission. The network entity may expect to receive ACK and/or NACK feedback for two PDSCH transmissions, e.g., the first and second scheduled PDSCH transmissions, however, thereby leading to a mismatch in understanding between the UE and the network entity.

In certain aspects, to handle these error cases, each downlink control message (e.g., scheduling a PDSCH transmission for the UE) may include a DAI. The DAI included in a downlink control message may be split into two parts: a cDAI and a tDAI. The cDAI included in the downlink control message may indicate a number of PDSCH transmissions that have been scheduled for the UE up to the point in time and up to the current serving cell (CC) when the downlink control message is sent to the UE. The tDAI included in the downlink control message may indicate a total number of PDSCH transmissions that have been scheduled for the UE across all CCs up to the point in time when the downlink control message is sent to the UE. In certain aspects, the downlink control message may include the cDAI and the tDAI as a tuple of (cDAI, tDAI). In certain aspects, for both cDAI and tDAI in the downlink control message, there may be a modulo 4 operation (e.g., 2 bits are used for the cDAI and 2 bits may be used for the tDAI).

This DAI mechanism may help to avoid misaligned codebooks between the UE and the network entity. Specifically, the UE may determine when it has missed a downlink control message based on receiving downlink control messages with non-consecutive cDAI values. As an illustrative example, a UE may receive a first downlink control message with cDAI=1 and receive a second downlink control message with cDAI=3. Based on the second downlink control message received by the UE including cDAI=3 instead of cDAI=2, the UE may determine that it has missed the downlink control message (e.g., scheduling a PDSCH transmission for the UE) with the cDAI=2. Based on this determination, the UE may know to include NACK feedback for the PDSCH transmission, scheduled by the missed downlink control message, in the codebook. In certain aspects, the UE may use the cDAI included in the third downlink control message to identify the codebook position where the NACK feedback should be inserted for the PDSCH transmission scheduled by the missed second downlink control message.

As another example, the UE may determine when it has missed a downlink control message based on comparing cDAI and tDAI included in a downlink control message used to schedule a PDSCH transmission in a PDSCH candidate occasion for the UE. As an illustrative example, a UE may receive, in a PDCCH monitoring occasion, a downlink control message with cDAI=1 and tDAI=2. Based on the tDAI being equal to two and the UE not receiving another downlink control message in the PDCCH monitoring occasion, the UE may determine that it has missed a downlink control message scheduling a PDSCH transmission for the UE. Based on this determination, the UE may know to include NACK feedback for the PDSCH transmission, scheduled by the missed downlink control message, in the codebook.

Both the cDAI and the tDAI may have a range from one to four, meaning a value of cDAI included in a downlink control message may be equal to one, two, three, or four, and a value of tDAI included in a downlink control message may be equal to one, two, three, or four. After a value of four is used for a cDAI included in a downlink control message, a next-in-time downlink control message with a cDAI may include a cDAI equal to 1 (e.g., the counter restarts). Similarly, after a value of four is used for a tDAI included in a downlink control message, a next-in-time downlink control message with a tDAI may include a tDAI equal to one.

FIG. 8 depicts example type II (e.g., dynamic) HARQ-ACK codebook-based feedback generation 800. As shown in FIG. 8, a UE 804 (e.g., such as UE 104 of FIG. 1 or UE 304 of FIG. 3) may be configured to use two CCs, CC0 and CC1, for communication with a network entity (not shown in FIG. 8). More specifically, downlink data message(s) (e.g., PDSCH transmission(s)) may be scheduled in at least slots 806, 808, and 810, via one or more downlink control messages (e.g., PDCCH transmission(s)). Additionally, uplink control message(s) (e.g., PUCCH transmission(s)) may be scheduled in slot 812 via one or more downlink control messages (e.g., PDCCH transmission(s)). CC0 and CC1 may be used to transmit, from the network entity to UE 704, PDCCH transmission(s) scheduling PDSCH transmission(s) in slots 806, 808, and 810, as well as the scheduled PDSCH transmission(s). Further, CC0 and CC1 may be used to transmit, from UE 804 to the network entity, PDCCH transmission(s) scheduling PUCCH transmission(s) in slot 812, as well as the scheduled PUCCH transmission(s).

In this example, CC0 may be used to communicate a maximum of two PDCCHs and a maximum of two PDSCHs per slot, for each of slots 806, 808, and 810. Thus, UE 804 may monitor two PDCCH monitoring occasions per slot, for each of slots 806, 808, and 810, for PDCCH transmissions via CC0. Further, UE 804 may monitor a maximum of two PDSCH candidate occasions per slot, for each of slots 806, 808, and 810, for PDSCH transmissions via CC0.

CC1, on the other hand, may be used to communicate a maximum of one PDCCH and a maximum of one PDSCH per slot, for each of slots 806, 808, and 810. Thus, UE 804 may monitor one PDCCH monitoring occasion per slot, for each of slots 806, 808, and 810, for a PDCCH transmission via CC1. Further, UE 804 may monitor a maximum of one PDSCH candidate occasion per slot, for each of slots 806, 808, and 810, for a PDSCH transmission via CC1.

As shown in FIG. 8, in slot 806, UE 804 may (1) receive, via CC0, a PDCCH 814 scheduling a PDSCH 816, (2) receive, via CC1, a PDCCH 830 scheduling a PDSCH 832, and (3) receive, via CC0, a PDCCH 818 scheduling a PDSCH 820.

PDCCH 814 (e.g., (1, 2)) may include a cDAI=1 indicating that PDCCH 814 is the first PDCCH sent to UE 804 and a tDAI=2 indicating that two PDCCHs (e.g., across CC0 and CC1), namely PDCCH 814 and PDCCH 830, have been sent to UE 804 up to this point in time when PDCCH 814 is sent. PDCCH 830 (e.g., (2,2)) may include a cDAI=2 indicating that PDCCH 830 is the second PDCCH sent to UE 804 and a tDAI=2 indicating that two PDCCHs, namely PDCCH 814 and PDCCH 830, have been sent to UE 804 up to this point in time when PDCCH 830 is sent. PDCCH 818 (e.g., (3, 3)) may include a cDAI=3 indicating that PDCCH 818 is the third PDCCH sent to UE 804 and a tDAI=3 indicating that three PDCCHs, namely PDCCH 814, PDCCH 830, and PDCCH 818, have been sent to UE 804 up to this point in time when PDCCH 818 is sent.

Based on receiving PDCCHs 814, 830, and 818, UE 804 may monitor for PDSCHs 816, 832, and 820, respectively, and include, in type II HARQ-ACK codebook-based feedback 850 (simply “feedback 850”), ACK or NACK (A/N) feedback for each PDSCH. For example, a first entry 840-1 in feedback 850 may include ACK or NACK feedback for PDSCH 816, a second entry 840-2 in feedback 850 may include ACK or NACK feedback for PDSCH 832, and a third entry 840-3 in feedback 850 may include ACK or NACK feedback for PDSCH 820.

In slot 808, UE 804 may fail to receive, via CC0, a PDCCH 822 scheduling a PDSCH 824. Thus, at this point in time, UE 804 may not know that the PDSCH 824 has been scheduled for UE 804.

In slot 810, UE 804 may (1) receive, via CC0, a PDCCH 826 scheduling a PDSCH 828. PDCCH 826 (e.g., (1, 2)) may include a cDAI=1 indicating that PDCCH 826 is another first PDCCH sent to UE 804 (e.g., the counter has restarted) and a tDAI=2 indicating that two PDCCHs (e.g., across CC0 and CC1), namely PDCCH 814 and PDCCH 834, have been sent to UE 804 up to this point in time when PDCCH 826 is sent.

UE 804 may determine that it has missed PDCCH 822 based on comparing the cDAI of PDCCH 818 (e.g., cDAI=3) with the cDAI of PDCCH 826 (e.g., cDAI=1). For example, UE 804 may determine that UE 804 has missed a PDCCH associated with cDAI=4 (e.g., PDCCH 822), given cDAI values are expected to increase up to a value of four before restarting with a value of one.

Based on determining that UE 804 has missed PDCCH 822 associated with cDAI=4, UE 804 may include, in feedback 850, NACK feedback for a PDSCH scheduled by PDCCH 822 (e.g., NACK feedback for PDSCH 824). For example, a fourth entry 840-4 in feedback 850 may include NACK feedback for PDSCH 824 scheduled by PDCCH 822. UE 804 may also include in a fifth entry 840-5, ACK or NACK feedback for PDSCH 828 scheduled by PDCCH 826.

Further, in slot 810, UE 804 may fail to receive, via CC1, a PDCCH 834 scheduling a PDSCH 836. In this example, UE 804 may determine that it has missed PDCCH 834 based on comparing the cDAI of PDCCH 826 (e.g., cDAI=1) with the tDAI of PDCCH 826 (e.g., tDAI=2). For example, UE 804 may determine that UE 804 has missed a PDCCH associated with cDAI=2 (e.g., PDCCH 834), given the cDAI indicates that PDCCH 826 is only the first (e.g., another first) PDCCH received by UE 804, a total of two DCIs should have been received by UE 804 (e.g., based on tDAI=2), and UE 804 has not received another PDCCH up to this point in time when PDCCH 826 is received.

Based on determining that UE 804 has missed PDCCH 834 associated with cDAI=2 and tDAI=2, UE 804 may include, in feedback 850, NACK feedback for a PDSCH scheduled by PDCCH 834 (e.g., NACK feedback for PDSCH 836). For example, a sixth entry 840-6 in feedback 850 may include NACK feedback for PDSCH 836 scheduled by PDCCH 834.

In this example, UE 804 may transmit, to the network entity, the feedback 850 via an uplink control message (e.g., PUCCH 838) scheduled in slot 812 using CC0. Specifically, CC0 may be used to transmit the feedback 850 to the network entity in a PCell associated with CC0.

As shown via the example in FIG. 8, the size of feedback 850 (e.g., the codebook) may be dynamic and thus depend on a number of PDSCHs that are scheduled for UE 804.

Type III HARQ-ACK codebook feedback, also referred to as “one-shot HARQ-ACK codebook feedback,” may include ACK and/or NACK feedback for all configured HARQ processes for all configured CCs in a PUCCH group. For example, where a UE is configured with four CCs, belonging to a same PUCCH group, and each CC is configured with 16 HARQ processes, a type III HARQ-ACK codebook may include 64 ACK/NACK bits (e.g., (4 CCs)*(16 HARQ processes)=64 ACK/NACK bits).

Type III HARQ-ACK codebook feedback may enable a network entity to request feedback for all configured downlink HARQ processes for all CCs configured for a UE and belonging to a same PUCCH group. For example, the network entity may send the request for this feedback in a downlink control message, such as a DCI having a DCI format 1_1 or 1_2. The DCI may include a DCI field, referred to as a “one-shot HARQ-ACK request” field with a single bit. In certain aspects, the DCI may be a downlink DCI that schedules a PDSCH. In certain aspects, the DCI may not be a downlink DCI that schedules a PDSCH. In cases where the DCI is a non-scheduling DCI, one value of a frequency domain resource assignment field of the DCI may indicate that this DCI does not schedule a PDSCH.

In certain aspects, type III HARQ-ACK codebook feedback may be configured with type I (e.g., semi-static) HARQ-ACK codebook feedback and/or type II (e.g., dynamic) HARQ-ACK codebook feedback.

In certain aspects where a UE is triggered to report both type III HARQ-ACK codebook feedback and other HARQ-ACK feedback in a same slot, the UE may report only the type III HARQ-ACK codebook feedback. Put differently, the type III HARQ-ACK codebook feedback may “replace” the other HARQ-ACK feedback that was originally requested to be reported.

In certain aspects, a UE may be configured with up to eight possibilities of type III HARQ-ACK codebook properties. Each possibility (e.g., of the up to eight possibilities) may correspond to a subset of CCs and a subset of HARQ identifiers (IDs) associated with each of those CCs in the subset of CCs.

As an illustrative example, each CC among two CCs may be associated 16 HARQ-IDs. For these CCs, a first possibility (e.g., “Codebook 1” or “CB1”) may be configured to include all 16 HARQ-IDs for each CC (e.g., (2 CCs)*(16 HARQ-IDs per CC)=32 HARQ processes). A second possibility (e.g., “CB2”) may be configured to include the first CC and all 16 HARQ-IDs. A third possibility (e.g., CB3) may be configured to include HARQ-IDs {0, 1, 2, 3} for the first CC and HARQ-IDs {2, 3, 4, 5, 6, 7, 8, 9, 10} for the second CC. Further, other possibilities may be considered for this example.

When type III HARQ-ACK codebook feedback is triggered by a DCI having DCI format 1_1 or 1_2, the DCI may also indicate which of the type III HARQ-ACK codebooks are requested to be reported (e.g., which of the up to eight possibilities are requested to be reported). The type III HARQ-ACK codebooks that are requested may indicated using another field of the DCI, which may include up to three bits.

In certain aspects, a UE may be configured (e.g., via radio resource control (RRC) signaling) to report a new data indictor (NDI) or not (e.g., such as in additional to ACK and/or NACK bits) for type III HARQ-ACK codebook feedback.

### Aspects Related to Harq-ack Codebook Construction and Transmission for Loose Carrier Aggregation Implementations

Aspects described herein improve upon the state of the art by providing techniques for HARQ-ACK codebook construction and transmission in loose carrier aggregation implementations. As described herein, a loose carrier aggregation implementation may may allow for the configuration of two distinct “cell groups” of CCs that are configured for use by a UE, such that HARQ-ACK codebook construction is performed separately and independently for each cell group. However, each HARQ-ACK codebook constructed for each cell group may be combined into a single codebook for transmission (e.g., to a network entity). In certain aspects, different HARQ-ACK codebook types for the distinct cell groups may be used.

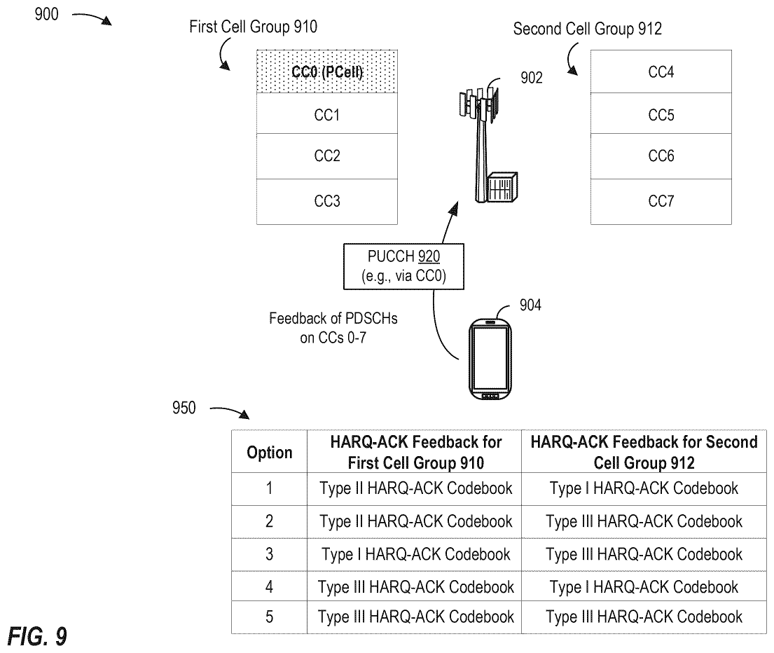

FIG. 9 depicts example HARQ-ACK codebook construction and transmission in a loose carrier aggregation implementation 900. As shown in FIG. 9, a UE 904 (e.g., such as UE 104 of FIG. 1 or UE 304 of FIG. 3) may be configured with eight CCs (e.g., CC0 through CC7) for communicating with a network entity 902 (e.g., such as BS 102 of FIG. 1, a first network entity 300 or second network entity 302 of FIG. 3, or a disaggregated base station as discussed with respect to FIG. 2). CC0 may be referred as a “primary CC” of UE 904, which may be used by UE 904 to communicate with network entity 902 in a PCell. CC1, CC2, CC3, CC4, CC5, CC6, and CC7 may each be referred to as a “secondary CC” of UE 904, which may be used by UE 904 to communicate with network entity 902 in a respective SCell (e.g., CC1 is used to communicate with network entity 902 in a first SCell, CC2 is used to communicate with network entity 902 in a second SCell, etc.).

In this example loose carrier aggregation implementation 900, a first subset of the CCs configured for use by UE 904, including CC0, CC1, CC2, and CC3, may be combined to form a first cell group 910. Further, a second subset of the CCs configured for use by UE 904, including CC4, CC5, CC6, and CC7, may be combined to form a second cell group 912.

In certain aspects, separate and independent codebook construction among the cell groups (e.g., first cell group 910 and second cell group 912) may be configured based on the separate configuration of HARQ-ACK codebook types for each cell group. For example, in certain aspects (not shown in FIG. 9), UE 904 may obtain first signaling configuring UE 904 to use a first HARQ-ACK codebook type for the first cell group 910 and second signaling configuring UE 904 to use a second HARQ-ACK codebook type for the second cell group 912. Based on the first signaling, UE 904 may generate HARQ-ACK feedback, for downlink transmission(s) scheduled via CC0, CC1, CC2, and/or CC3, which is formatted according to the first HARQ-ACK codebook type. Further, based on the second signaling, UE 904 may generate HARQ-ACK feedback, for downlink transmission(s) scheduled via CC4, CC5, CC6, and/or CC7, which is formatted according to the second HARQ-ACK codebook type.

As shown via table 950 in FIG. 9, various codebook type combinations may be considered and configured for the first cell group 910 and the second cell group 912. For example, in a first option, UE 904 may be configured to format HARQ-ACK feedback for first cell group 910 according to the type II HARQ-ACK codebook and format HARQ-ACK feedback for second cell group 912 according to the type I HARQ-ACK codebook (e.g., type 1+type 2). In a second option, UE 904 may be configured to format HARQ-ACK feedback for first cell group 910 according to the type II HARQ-ACK codebook and format HARQ-ACK feedback for second cell group 912 according to the type III HARQ-ACK codebook (e.g., type 2+type 3). In a third option, UE 904 may be configured to format HARQ-ACK feedback for first cell group 910 according to the type I HARQ-ACK codebook and format HARQ-ACK feedback for second cell group 912 according to the type III HARQ-ACK codebook (e.g., type 1+type 3). In a fourth option, UE 904 may be configured to format HARQ-ACK feedback for first cell group 910 according to the type III HARQ-ACK codebook and format HARQ-ACK feedback for second cell group 912 according to the type I HARQ-ACK codebook (e.g., type 3+type 1). In a fifth option, UE 904 may be configured to format HARQ-ACK feedback for first cell group 910 according to the type III HARQ-ACK codebook and format HARQ-ACK feedback for second cell group 912 according to the type III HARQ-ACK codebook (e.g., type 3+type 3).

In certain aspects, the second signaling may not configure UE 904 to use the type II HARQ-ACK codebook for HARQ-ACK codebook construction (e.g., may not configure UE 904 with type 1/2/3+type 2).

Additionally, in this example loose carrier aggregation implementation 900, the HARQ-ACK codebook-based feedback constructed for the first cell group 910 may be multiplexed with HARQ-ACK codebook-based feedback constructed for the second cell group 912 and sent as a single codebook for transmission. For example, in certain aspects as shown in FIG. 9, the HARQ-ACK codebook-based feedback for first cell group 910 and the HARQ-ACK codebook-based feedback for second cell group 912 may be multiplexed and sent to the network entity via an uplink control message, e.g., PUCCH 920, scheduled in first cell group 910. CC0 may be used to transmit the PUCCH 920 (e.g., including the multiplexed HARQ-ACK codebook-based feedback) to the network entity in the PCell.

In certain other aspects (not shown in FIG. 9), the HARQ-ACK codebook-based feedback for first cell group 910 and the HARQ-ACK codebook-based feedback for second cell group 912 may be multiplexed and sent to the network entity via an uplink data message, e.g., a PUSCH, scheduled in first cell group 910. For example, where PUCCH 920 overlaps the PUSCH in a time domain, the multiplexed HARQ-ACK codebook-based feedback may, in some cases, be sent to the network entity via the PUSCH of the first cell group 910.

In certain other aspects (not shown in FIG. 9), the HARQ-ACK codebook-based feedback for first cell group 910 and the HARQ-ACK codebook-based feedback for second cell group 912 may be multiplexed and sent to the network entity via an uplink data message, e.g., a PUSCH, scheduled in second cell group 912. For example, where PUCCH 920 overlaps the PUSCH in a time domain, the multiplexed HARQ-ACK codebook-based feedback may, in some cases, be sent to the network entity via the PUSCH of the second cell group 912.

### Example Signaling for HARQ-ACK Codebook Construction and Transmission in a Loose Carrier Aggregation Implementation

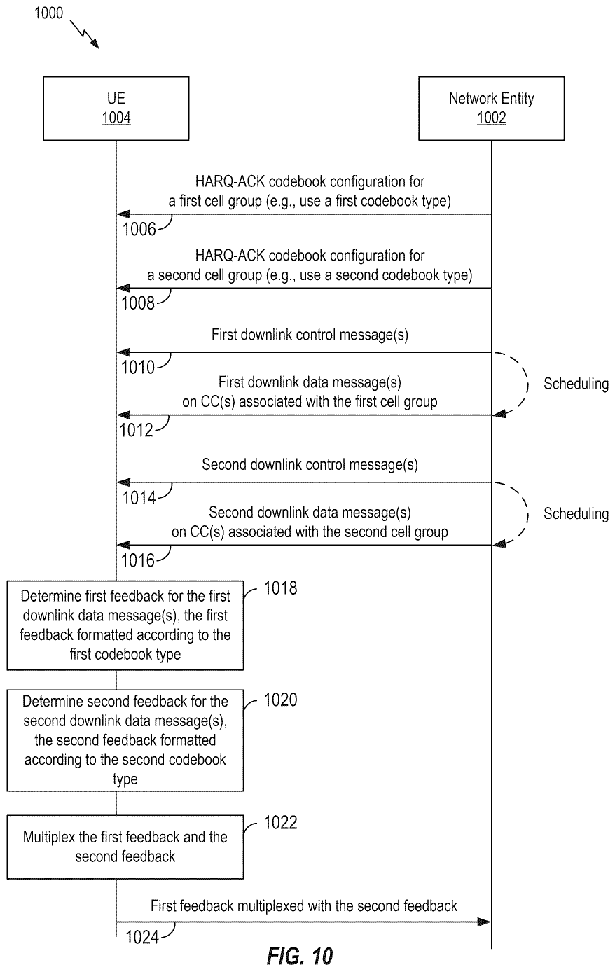

FIG. 10 depicts a process flow 1000 for communications in a network between a network entity 1002 and a UE 1004. In certain aspects, the network entity 1002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1004 may be an example of UE 104 depicted and described with respect to FIG. 1 or the UE 304 depicted and described with respect to FIG. 3. However, in other aspects, UE 1004 may be another type of wireless communications device and network entity 1002 may be another type of network entity or network node, such as those described herein. Note that any operations or signaling illustrated with dashed lines may indicate that that operation or signaling is an optional or alternative example.

In certain aspects, communications between network entity 10002 and UE 1004 in process flow 1000 may be used for HARQ-ACK codebook construction and transmission in a loose carrier aggregation implementation (e.g., such as example loose carrier aggregation implementation 900 of FIG. 9).

In FIG. 10, UE 1004 may be configured with multiple CCs (not shown) for communicating with network entity 1002. In certain aspects, a first subset of the multiple CCs configured for use by UE 1004 may be combined to form a first cell group. Further, a second subset of the CCs configured for use by UE 1004 may be combined to form a second cell group. The first cell group may include CCs, which may be used by UE 1004 to communicate with network entity 1002 in a PCell and/or one or more SCells. The second cell group may include CCs, which may be used by UE 1004 to communicate with network entity 1002 in two or more other SCells.

Process flow 1000 begins, at 1006, with network entity 1002 transmitting, and UE 1004 receiving, a HARQ-ACK codebook configuration for the first cell group. For example, network entity 1002 may transmit, to UE 1004, first signaling that configures UE 1004 to use a first codebook type for the first cell group. The first codebook type may comprise a type I, type II, or the type III HARQ-ACK codebook.

At 1008, network entity 1002 transmits, to UE 1004, a HARQ-ACK codebook configuration for the second cell group. For example, network entity 1002 may transmit, to UE 1004, second signaling that configures UE 1004 to use a second codebook type for the first cell group. The second codebook type may comprise the type I or the type III HARQ-ACK codebook (not the type II HARQ-ACK codebook).

At 1010, network entity 1002 transmits, to UE 1004, one or more first downlink control messages (e.g. second PDCCH(s) carrying DCI). The first downlink control message(s) may be transmitted to UE 1004 using CC(s) in the first cell group. Each first downlink control message may schedule a downlink data message (e.g., a first PDSCH) on a CC (e.g., via a CC) of the first cell group. For example, in one example, network entity 1002, may transmit, to UE 1004, three first downlink control messages that schedule three downlink data messages. The three downlink data messages may be scheduled such that they are sent to UE 1004 via one or more CCs of the first cell group.

At 1012, network entity 1002 transmits, to UE 1004, the scheduled first downlink data message(s). The scheduled first downlink data message(s) may be sent on CC(s) associated with the first cell group.

At 1014, network entity 1002 transmits, to UE 1004, one or more second downlink control messages (e.g. second PDCCH(s) carrying DCI). The second downlink control message(s) may be transmitted to UE 1004 using CC(s) in the second cell group. Each second downlink control message may schedule a downlink data message (e.g., a second PDSCH) on a CC (e.g., via a CC) of the second cell group. For example, in one example, network entity 1002, may transmit, to UE 1004, two second downlink control messages that schedule two downlink data messages. The two downlink data messages may be scheduled such that they are transmitted to UE 1004 via one or more CCs of the second cell group.

At 1016, network entity 1002 transmits, to UE 1004, the scheduled second downlink data message(s). The scheduled second downlink data message(s) may be transmitted on CC(s) associated with the second cell group.

At 1018, UE 1004 determines first feedback for the first downlink data message(s). The first feedback may include HARQ-ACK feedback for the first downlink data message(s), which may be formatted according to the first codebook type (e.g., configured for the first cell group via the HARQ-ACK codebook configuration sent to UE 1004 at 1006). For example, where the first codebook type is the type II HARQ-ACK codebook, then at 1018, UE 1004 may construct a type II HARQ-ACK codebook (e.g., a dynamic codebook) including ACK and/or NACK feedback for each of the scheduled downlink data message(s) (e.g., scheduled via the first downlink control message(s) sent to UE 1004 at 1010).

At 1020, UE 1004 determines second feedback for the second downlink data message(s). The second feedback may include HARQ-ACK feedback for the second downlink data message(s), which may be formatted according to the second codebook type (e.g., configured for the second cell group via the HARQ-ACK codebook configuration sent to UE 1004 at 1008). For example, where the second codebook type is the type I HARQ-ACK codebook, then at 1020, UE 1004 may construct a type I HARQ-ACK codebook including ACK and/or NACK feedback for a fixed number of PDSCH candidate occasions (e.g., within a K1 window, as described above with respect to FIG. 6).

At 1022, UE 1004 multiplexes the first feedback and the second feedback together to generate a single codebook for transmission.

At 1024, UE 1004 transmits, to network entity 1002, the first feedback multiplexed with the second feedback.

In certain aspects, UE 1004 transmits, to network entity 1002, the first feedback multiplexed with the second feedback via an uplink control message (e.g., a PUCCH) scheduled in a first cell (e.g., a PCell) of the first cell group.

In certain other aspects, UE 1004 transmits, to network entity 1002, the first feedback multiplexed with the second feedback via an uplink data message (e.g., a PUSCH) scheduled in the first cell (e.g., a PCell) of the first cell group. For example (not shown in FIG. 10), network entity 1002 may send, to UE 1004, another downlink data message (e.g., another PDCCH with DCI) scheduling the uplink data message (e.g., the PUSCH) in the first cell of the first cell group. In certain aspects, the uplink data message may overlap, in a time domain, the uplink control message, also scheduled in the first cell of the first cell group.

In certain other aspects, UE 1004 transmits, to network entity 1002, the first feedback multiplexed with the second feedback via an uplink data message (e.g., a PUSCH) scheduled in a second cell (e.g., a SCell) of the second cell group. For example (not shown in FIG. 10), network entity 1002 may send, to UE 1004, another downlink data message (e.g., another PDCCH with DCI) scheduling the uplink data message (e.g., the PUSCH) in the second cell of the second cell group. In certain aspects, the uplink data message scheduled in the second cell of the second cell group may overlap, in the time domain, the uplink control message, also scheduled in the first cell of the first cell group.

Although not shown in FIG. 10, network entity may use the first feedback and the second feedback to determine which of the first and second downlink data message(s) were successfully received and decoded by UE 1004, and which of the first and second downlink data message(s) need to be re-transmitted to UE 1004.

Different HARQ-ACK codebook type combinations configured for the first cell group and the second cell group in FIG. 10 (e.g., at 1006 and 1008) may necessitate different DCI field(s) and/or information in DCIs scheduling downlink data messages (e.g., for which HARQ-ACK feedback is provided) and/or uplink data messages in each of the cell groups. The different DCI field(s) and/or information of DCIs used when different codebook type combinations are configured for the distinct cell groups are described in detail below.

### HARQ-ACK Codebook Type Combination: Type II HARQ-ACK Codebook+Type i HARQ-ACK Codebook

In certain aspects, the first codebook type (e.g. configured at 1006 in FIG. 10 comprises a type II HARQ-ACK codebook, and the second codebook type (e.g., configured at 1008 in FIG. 10) comprises a type I HARQ-ACK codebook.

For this HARQ-ACK codebook type combination, each first downlink control message associated with the first cell group (e.g., sent to UE 1004 at 1010 and scheduling a first downlink data message at 1012) (e.g., “DL DCI” for the first cell group) may include a cDAI field (e.g., two bits) for the first cell group (e.g., given type II HARQ-ACK feedback is to generated for the first cell group). In certain aspects, when the first cell group includes more than one CC, each first downlink control message associated with the first cell group may further include a tDAI field for the first cell group. How the cDAI field and the tDAI field (e.g., two bits) are used when constructing type II HARQ-ACK codebook-based feedback is depicted and described above with respect to FIG. 8.

Each second downlink control message associated with the second cell group (e.g., sent to UE 1004 at 1014 and scheduling a second downlink data message at 1016) (e.g., “DL DCI” for the second cell group) may not include a cDAI field and may not include a tDAI field for the second cell group.

In certain aspects (not shown in FIG. 10), network entity 1002 may send, to UE 1004, a downlink control message that schedules one or more uplink data messages (e.g., one or more PUSCHs) for the first cell group. This downlink control message may be referred to as an “UL DCI” for the first cell group. In certain aspects, this downlink control message may include two tDAI fields. For example, a first tDAI field (e.g., two bits) for the first cell group may be included in the downlink control message. Further, a second tDAI field (e.g., 1 bit) may be included in the downlink control message and indicate whether to multiplex the second feedback for the second cell group (e.g., generated at 1020) with the first feedback for the first cell group (e.g., generated at 1018) for transmission via one of the uplink data messages (e.g., a PUSCH) scheduled for the first cell group. In certain aspects, the second tDAI field may be included in the downlink control message and indicate whether to multiplex the second feedback for the second cell group (e.g., generated at 1020) on an uplink data message (e.g., a PUSCH) scheduled for the first cell group (e.g., here, “multiplexing” may refer to multiplexing on the PUSCH). In this example, the second tDAI field may indicate to multiplex the second feedback with the first feedback and multiplex the transmission on an uplink data message (e.g., a PUSCH) scheduled in a first cell associated with the first cell group.

In certain aspects (not shown in FIG. 10), network entity 1002 may send, to UE 1004, a downlink control message that schedules one or more uplink data messages (e.g., one or more PUSCHs) for the second cell group. This downlink control message may be referred to as an “UL DCI” for the second cell group. In certain aspects, this downlink control message may include this downlink control message may include two tDAI fields. For example, a first tDAI field (e.g., two bits) for the first cell group may be included in the downlink control message. Further, a second tDAI field (e.g., 1 bit) may be included in the downlink control message may include two tDAI fields. For example, a first tDAI field for the first cell group and a second tDAI field for the second cell group may be included in the downlink control message.

In certain other aspects, this downlink control message may not include a DAI field. For example, this downlink control message may not include a cDAI field, may not include a tDAI field for the first cell group, and may not include a tDAI field for the second cell group. More specifically, a DAI field may not be included for either the first cell group or the second cell group. In this case, it may be assumed that HARQ-ACK feedback (e.g., the first feedback multiplexed with the second feedback) can only be multiplexed on an uplink data message (e.g., a PUSCH) scheduled for the first cell group (e.g., if the uplink data message overlaps with the an uplink control message scheduled for the first cell group), and cannot be multiplexed on an uplink data message (e.g., a PUSCH) scheduled for the second cell group (e.g., the uplink data message overlaps with the an uplink control message scheduled for the first cell group).

### HARQ-ACK Codebook Type Combination: Type II HARQ-ACK Codebook+Type III HARQ-ACK Codebook

For this HARQ-ACK codebook type combination (similar to the previous combination), each first downlink control message associated with the first cell group (e.g., sent to UE 1004 at 1010 and scheduling a first downlink data message at 1012) (e.g., “DL DCI” for the first cell group) may include a cDAI field (e.g., two bits) for the first cell group (e.g., given type II HARQ-ACK feedback is to generated for the first cell group). In certain aspects, when the first cell group includes more than one CC, each first downlink control message associated with the first cell group may further include a tDAI field for the first cell group.

Each second downlink control message associated with the second cell group (e.g., sent to UE 1004 at 1014 and scheduling a second downlink data message at 1016) (e.g., “DL DCI” for the second cell group) may not include a cDAI field and may not include a tDAI field for the second cell group.

In certain aspects (not shown in FIG. 10), network entity 1002 may send, to UE 1004, a downlink control message that schedules one or more uplink data messages (e.g., one or more PUSCHs) for the first cell group. This downlink control message may be referred to as an “UL DCI” for the first cell group. In certain aspects, this downlink control message may include one tDAI field. For example, the tDAI field in the downlink control message may be associated with the first cell group. A second tDAI field in the downlink control message and associated with the second cell group may not be included, as this second tDAI field may be specific to type I HARQ-ACK codebook generation and for this combination, the second feedback is generated according to the type III HARQ-ACK codebook.

In certain aspects (not shown in FIG. 10), network entity 1002 may send, to UE 1004, a downlink control message that schedules one or more uplink data messages (e.g., one or more PUSCHs) for the second cell group. This downlink control message may be referred to as an “UL DCI” for the second cell group. In certain aspects, this downlink control message may include a first tDAI field for the first cell group but may not include a second tDAI field for the second cell group. In this case, the first feedback for the first cell group (e.g., generated at 1018) multiplexed with the second feedback for the second cell group (e.g., generated at 1020) may be transmitted via an uplink control message (e.g., a PUCCH) scheduled in a first cell associated with the first cell group.

In certain other aspects, this downlink control message may not include a cDAI field and may not include a tDAI field for the first cell group. More specifically, a DAI field may not be included for either the first cell group or the second cell group. In this case, it may be assumed that HARQ-ACK feedback (e.g., the first feedback multiplexed with the second feedback) can only be multiplexed on an uplink data message (e.g., a PUSCH) scheduled for the first cell group (e.g., if the uplink data message overlaps with the an uplink control message scheduled for the first cell group), and cannot be multiplexed on an uplink data message (e.g., a PUSCH) scheduled for the first cell group (e.g., the uplink data message overlaps with the an uplink control message scheduled for the first cell group).

In certain aspects, type III HARQ-ACK codebook transmission may need to be triggered for the second cell group (e.g., configured to generate HARQ-ACK feedback according to the type III HARQ-ACK codebook).

In certain aspects, only first downlink control messages associated with the first cell group (e.g., sent to UE 1004 at 1010 and scheduling first downlink data messages at 1012) may be used to trigger type III HARQ-ACK codebook transmission for the second cell group. For example, at least one of the first downlink control messages may include a one-shot feedback request field. In certain aspects, the one-shot feedback request field included in the first downlink control message may indicate, to UE 1004, to send the second feedback (e.g., type III HARQ-ACK codebook-based feedback) for the second downlink data message(s) (e.g., transmitted at 1016). Further, in certain aspects, the first downlink control message may include an enhanced type III HARQ-ACK codebook indicator field that indicates, for the second feedback, one or more enhanced type III HARQ-ACK codebooks to send for the second feedback. As described herein, with regular type III HARQ-ACK codebook-based feedback, a DCI may not select between different type III HARQ-ACK codebooks. Put differently, the DCI may only trigger ACK/NACK feedback for all HARQ IDs/all CCs, but not for specific subsets. However, with enhanced type III HARQ-ACK codebook-based feedback, a DCI may select between the different type III HARQ-ACK codebooks.

In certain other aspects, only second downlink control messages associated with the second cell group (e.g., sent to UE 1004 at 1014 and scheduling second downlink data messages at 1016) may be used to trigger type III HARQ-ACK codebook construction and transmission for the second cell group. For example, at least one of the second downlink control messages may include a one-shot feedback request field. In certain aspects, the one-shot feedback request field included in the second downlink control message may indicate, to UE 1004, to send the second feedback (e.g., type III HARQ-ACK codebook-based feedback) for the second downlink data message(s) (e.g., transmitted at 1016). Further, in certain aspects, the second downlink control message may include an enhanced type III HARQ-ACK codebook indicator field that indicates, for the second feedback, one or more enhanced type III HARQ-ACK codebooks to send for the second feedback.

In certain other aspects, first downlink control messages associated with the first cell group (e.g., sent to UE 1004 at 1010 and scheduling first downlink data messages at 1012) and/or second downlink control messages associated with the second cell group (e.g., sent to UE 1004 at 1014 and scheduling second downlink data messages at 1016) may be used to trigger type III HARQ-ACK codebook transmission for the second cell group. For example, at least one of the first downlink control messages and/or one of the second downlink control messages may include a one-shot feedback request field used to trigger UE 1004 to send the second feedback. Further, in certain aspects, at least one of the first downlink control messages and/or one of the second downlink control messages may include an enhanced type III HARQ-ACK codebook indicator field that indicates, for the second feedback, one or more enhanced type III HARQ-ACK codebooks to send for the second feedback.

In certain aspects where one or more enhanced type III HARQ-ACK codebooks are indicated to be transmitted, a restriction may be added such that different enhanced type III HARQ-ACK codebooks that are sent for the second cell group each have the same size. In certain aspects, this may cause the payload size of the type III HARQ-ACK codebook-based feedback to be fixed. The fixed codebook size may enable scheduling of the uplink transmission in the PCell for the first cell group, as well as allow for decoding of the HARQ-ACK feedback by network entity 1002, irrespective of the second cell group's decision.

### HARQ-ACK Codebook Type Combination: Type I HARQ-ACK Codebook+Type III HARQ-ACK Codebook

In certain aspects, the first codebook type (e.g. configured at 1006 in FIG. 10 comprises a type I HARQ-ACK codebook, and the second codebook type (e.g., configured at 1008 in FIG. 10) comprises a type III HARQ-ACK codebook.

For this HARQ-ACK codebook type combination, each first downlink control message associated with the first cell group (e.g., sent to UE 1004 at 1010 and scheduling a first downlink data message at 1012) (e.g., “DL DCI” for the first cell group) may not include a cDAI field and may not include a tDAI field. Specifically, such DAI fields may not be relevant for HARQ-ACK codebook-based feedback construction for the first cell group.

Each second downlink control message associated with the second cell group (e.g., sent to UE 1004 at 1014 and scheduling a second downlink data message at 1016) (e.g., “DL DCI” for the second cell group) may not include a cDAI field and may not include a tDAI field. Specifically, such DAI fields may not be relevant for HARQ-ACK codebook-based feedback construction for the second cell group.

In certain aspects (not shown in FIG. 10), network entity 1002 may send, to UE 1004, a downlink control message that schedules one or more uplink data messages (e.g., one or more PUSCHs) for the first cell group. This downlink control message may be referred to as an “UL DCI” for the first cell group. In certain aspects, this downlink control message may include a tDAI field (e.g., 1 bit) for the first cell group. In certain aspects, this tDAI field may be included in the downlink control message and indicate whether to multiplex the first feedback for the first cell group (e.g., generated at 1018) with the second feedback for the second cell group (e.g., generated at 1020) for transmission via one of the uplink data messages (e.g., a PUSCH) scheduled for the first cell group. In certain aspects, this tDAI field may be included in the downlink control message and indicate whether to multiplex the first feedback for the first cell group (e.g., the type I HARQ-ACK codebook feedback generated at 1018) on an uplink data message (e.g., a PUSCH) scheduled for the first cell group (e.g., here, “multiplexing” may refer to multiplexing on the PUSCH). In this example, the tDAI field may indicate to multiplex the first feedback with the second feedback and further multiplex the transmission on an uplink data message (e.g., a PUSCH) scheduled in a first cell associated with the first cell group.

In certain aspects (not shown in FIG. 10), network entity 1002 may send, to UE 1004, a downlink control message that schedules one or more uplink data messages (e.g., one or more PUSCHs) for the second cell group. This downlink control message may be referred to as an “UL DCI” for the second cell group. In certain aspects, this downlink control message may include a tDAI field for the first cell group. In this case, the first feedback for the first cell group (e.g., generated at 1018) multiplexed with the second feedback for the second cell group (e.g., generated at 1020) may be transmitted on an uplink data message (e.g., a PUSCH) scheduled in a second cell associated with the second cell group.

In certain other aspects, this downlink control message may not include a tDAI field for the first cell group. More specifically, a DAI field may not be included for either the first cell group or the second cell group. In this case, it may be assumed that HARQ-ACK feedback (e.g., the first feedback multiplexed with the second feedback) can only be multiplexed on an uplink data message (e.g., a PUSCH) scheduled for the first cell group (e.g., if the uplink data message overlaps with the an uplink control message scheduled for the first cell group), and cannot be multiplexed on an uplink data message (e.g., a PUSCH) scheduled for the second cell group (e.g., the uplink data message overlaps with the an uplink control message scheduled for the first cell group).

In certain aspects, type III HARQ-ACK codebook transmission may need to be triggered for the second cell group (e.g., configured to generate HARQ-ACK feedback according to the type III HARQ-ACK codebook).

In certain aspects, only first downlink control messages associated with the first cell group (e.g., sent to UE 1004 at 1010 and scheduling first downlink data messages at 1012) may be used to trigger type III HARQ-ACK codebook transmission for the second cell group. For example, at least one of the first downlink control messages may include a one-shot feedback request field. In certain aspects, the one-shot feedback request field included in the first downlink control message may indicate, to UE 1004, to send the second feedback (e.g., type III HARQ-ACK codebook-based feedback) for the second downlink data message(s) (e.g., transmitted at 1016). Further, in certain aspects, the first downlink control message may include an enhanced type III HARQ-ACK codebook indicator field that indicates, for the second feedback, one or more enhanced type III HARQ-ACK codebooks to send for the second feedback.

In certain other aspects, only second downlink control messages associated with the second cell group (e.g., sent to UE 1004 at 1014 and scheduling second downlink data messages at 1016) may be used to trigger type III HARQ-ACK codebook construction and transmission for the second cell group. For example, at least one of the second downlink control messages may include a one-shot feedback request field. In certain aspects, the one-shot feedback request field included in the second downlink control message may indicate, to UE 1004, to send the second feedback (e.g., type III HARQ-ACK codebook-based feedback) for the second downlink data message(s) (e.g., transmitted at 1016). Further, in certain aspects, the second downlink control message may include an enhanced type III HARQ-ACK codebook indicator field that indicates, for the second feedback, one or more enhanced type III HARQ-ACK codebooks to send for the second feedback.

In certain other aspects, first downlink control messages associated with the first cell group (e.g., sent to UE 1004 at 1010 and scheduling first downlink data messages at 1012) and/or second downlink control messages associated with the second cell group (e.g., sent to UE 1004 at 1014 and scheduling second downlink data messages at 1016) may be used to trigger type III HARQ-ACK codebook transmission for the second cell group. For example, at least one of the first downlink control messages and/or one of the second downlink control messages may include a one-shot feedback request field used to trigger UE 1004 to send the second feedback. Further, in certain aspects, at least one of the first downlink control messages and/or one of the second downlink control messages may include an enhanced type III HARQ-ACK codebook indicator field that indicates, for the second feedback, one or more enhanced type III HARQ-ACK codebooks to send for the second feedback.

In certain aspects where one or more enhanced type III HARQ-ACK codebooks are indicated to be transmitted, a restriction may be added such that different enhanced type III HARQ-ACK codebooks that are sent for the second cell group each have the same size. In certain aspects, this may cause the payload size of the type III HARQ-ACK codebook-based feedback to be fixed. The fixed codebook size may enable scheduling of the uplink transmission in the PCell for the first cell group, as well as allow for decoding of the HARQ-ACK feedback by network entity 1002, irrespective of the second cell group's decision.

### HARQ-ACK Codebook Type Combination: Type III HARQ-ACK Codebook+Type I HARQ-ACK Codebook

In certain aspects, the first codebook type (e.g. configured at 1006 in FIG. 10 comprises a type III HARQ-ACK codebook, and the second codebook type (e.g., configured at 1008 in FIG. 10) comprises a type I HARQ-ACK codebook.

For this HARQ-ACK codebook type combination, each first downlink control message associated with the first cell group (e.g., sent to UE 1004 at 1010 and scheduling a first downlink data message at 1012) (e.g., “DL DCI” for the first cell group) may not include a cDAI field and may not include a tDAI field. Specifically, such DAI fields may not be relevant for HARQ-ACK codebook-based feedback construction for the first cell group.

Each second downlink control message associated with the second cell group (e.g., sent to UE 1004 at 1014 and scheduling a second downlink data message at 1016) (e.g., “DL DCI” for the second cell group) may not include a cDAI field and may not include a tDAI field. Specifically, such DAI fields may not be relevant for HARQ-ACK codebook-based feedback construction for the second cell group.

In certain aspects (not shown in FIG. 10), network entity 1002 may send, to UE 1004, a downlink control message that schedules one or more uplink data messages (e.g., one or more PUSCHs) for the first cell group. This downlink control message may be referred to as an “UL DCI” for the first cell group. In certain aspects, this downlink control message may include a tDAI field (e.g., 1 bit) for the second cell group. This tDAI field may be included in the downlink control message and indicate whether to multiplex the second feedback for the second cell group (e.g., generated at 1020) with first feedback for the first cell group (e.g., generated at 1018) for transmission via one of the uplink data messages (e.g., a PUSCH) scheduled for the first cell group. In certain aspects, this tDAI field may be included in the downlink control message and indicate whether to multiplex the second feedback for the second cell group (e.g., the type I HARQ-ACK codebook feedback generated at 1020) on an uplink data message (e.g., a PUSCH) scheduled for the first cell group (e.g., here, “multiplexing” may refer to multiplexing on the PUSCH). In this example, the tDAI field may indicate to multiplex the second feedback with the first feedback and further multiplex the transmission on an uplink data message (e.g., a PUSCH) scheduled in a first cell associated with the first cell group.

In certain aspects (not shown in FIG. 10), network entity 1002 may send, to UE 1004, a downlink control message that schedules one or more uplink data messages (e.g., one or more PUSCHs) for the second cell group. This downlink control message may be referred to as an “UL DCI” for the second cell group. In certain aspects, this downlink control message may include a tDAI field for the second cell group. In this case, the second feedback for the second cell group (e.g., generated at 1020) with first feedback for the first cell group (e.g., generated at 1018) may be transmitted on an uplink data message (e.g., a PUSCH) scheduled in a second cell associated with the second cell group.

In certain other aspects, this downlink control message may not include a tDAI field for the second cell group. More specifically, a DAI field may not be included for either the first cell group or the second cell group. In this case, it may be assumed that HARQ-ACK feedback (e.g., the first feedback multiplexed with the second feedback) can only be multiplexed on an uplink data message (e.g., a PUSCH) scheduled for the first cell group (e.g., if the uplink data message overlaps with the an uplink control message scheduled for the first cell group), and cannot be multiplexed on an uplink data message (e.g., a PUSCH) scheduled for the second cell group (e.g., the uplink data message overlaps with the an uplink control message scheduled for the first cell group).

In certain aspects, type III HARQ-ACK codebook transmission may need to be triggered for the first cell group (e.g., configured to generate HARQ-ACK feedback according to the type III HARQ-ACK codebook).

In certain aspects, only first downlink control messages associated with the first cell group (e.g., sent to UE 1004 at 1010 and scheduling first downlink data messages at 1012) may be used to trigger type III HARQ-ACK codebook transmission for the first cell group. For example, at least one of the first downlink control messages may include a one-shot feedback request field. In certain aspects, the one-shot feedback request field included in the first downlink control message may indicate, to UE 1004, to send the first feedback (e.g., type III HARQ-ACK codebook-based feedback) for the first downlink data message(s) (e.g., transmitted at 1012). Further, in certain aspects, the first downlink control message may include an enhanced type III HARQ-ACK codebook indicator field that indicates, for the first feedback, one or more enhanced type III HARQ-ACK codebooks to send for the first feedback.

In certain aspects, the first cell group may be configured to use both type II and type III HARQ-ACK codebooks (e.g., when type III HARQ-ACK codebook transmission is not configured, type II HARQ-ACK codebook-based feedback may be generated for the first cel group). In this case, the presence of DAI fields in downlink DCIs and/or uplink DCIs for the first cell group may be similar to the DAI fields included in downlink DCIs and/or uplink DCIs for the first cell group for (1) the HARQ-ACK codebook type combination of type II HARQ-ACK codebook+type I HARQ-ACK codebook and (2) the HARQ-ACK codebook type combination of type II HARQ-ACK codebook+type III HARQ-ACK codebook. This may be the case because the type III HARQ-ACK codebook may be a standalone codebook type. However, the same not may not be applicable for the second cell group. For example, for the HARQ-ACK codebook type combination of type I HARQ-ACK codebook+type III HARQ-ACK codebook, the second cell group may be configured to use both type II and type III HARQ-ACK codebooks, and this may defeat the purpose. Specifically, if the second cell group is configured to use both type II and type III HARQ-ACK codebooks, the codebook size may be dynamic (e.g., when the type II HARQ-ACK codebook is used). Hence, in certain aspects, unlike the first cell group, configuring type II and type III HARQ-ACK codebooks for the second cell group may not be allowed.

### HARQ-ACK Codebook Type Combination: Type III HARQ-ACK Codebook+Type III HARQ-ACK Codebook

In certain aspects, the first codebook type (e.g. configured at 1006 in FIG. 10 comprises a type III HARQ-ACK codebook, and the second codebook type (e.g., configured at 1008 in FIG. 10) comprises a type III HARQ-ACK codebook.

In certain aspects, type III HARQ-ACK codebook transmission may need to be triggered for the first cell group (e.g., configured to generate HARQ-ACK feedback according to the type III HARQ-ACK codebook).

In certain aspects, only first downlink control messages associated with the first cell group (e.g., sent to UE 1004 at 1010 and scheduling first downlink data messages at 1012) may be used to trigger type III HARQ-ACK codebook transmission for the first cell group. For example, at least one of the first downlink control messages may include a one-shot feedback request field. In certain aspects, the one-shot feedback request field included in the first downlink control message may indicate, to UE 1004, to send the first feedback (e.g., type III HARQ-ACK codebook-based feedback) for the first downlink data message(s) (e.g., transmitted at 1012). Further, in certain aspects, the first downlink control message may include an enhanced type III HARQ-ACK codebook indicator field that indicates, for the first feedback, one or more enhanced type III HARQ-ACK codebooks to send for the first feedback.

In certain aspects, type III HARQ-ACK codebook transmission may need to be triggered for the second cell group (e.g., configured to generate HARQ-ACK feedback according to the type III HARQ-ACK codebook).

In certain aspects, only first downlink control messages associated with the first cell group (e.g., sent to UE 1004 at 1010 and scheduling first downlink data messages at 1012) may be used to trigger type III HARQ-ACK codebook transmission for the second cell group. For example, at least one of the first downlink control messages may include a one-shot feedback request field. In certain aspects, the one-shot feedback request field included in the first downlink control message may indicate, to UE 1004, to send the second feedback (e.g., type III HARQ-ACK codebook-based feedback) for the second downlink data message(s) (e.g., transmitted at 1016). Further, in certain aspects, the first downlink control message may include an enhanced type III HARQ-ACK codebook indicator field that indicates, for the second feedback, one or more enhanced type III HARQ-ACK codebooks to send for the second feedback.

In certain other aspects, only second downlink control messages associated with the second cell group (e.g., sent to UE 1004 at 1014 and scheduling second downlink data messages at 1016) may be used to trigger type III HARQ-ACK codebook construction and transmission for the second cell group. For example, at least one of the second downlink control messages may include a one-shot feedback request field. In certain aspects, the one-shot feedback request field included in the second downlink control message may indicate, to UE 1004, to send the second feedback (e.g., type III HARQ-ACK codebook-based feedback) for the second downlink data message(s) (e.g., transmitted at 1016). Further, in certain aspects, the second downlink control message may include an enhanced type III HARQ-ACK codebook indicator field that indicates, for the second feedback, one or more enhanced type III HARQ-ACK codebooks to send for the second feedback.

In certain other aspects, first downlink control messages associated with the first cell group (e.g., sent to UE 1004 at 1010 and scheduling first downlink data messages at 1012) and/or second downlink control messages associated with the second cell group (e.g., sent to UE 1004 at 1014 and scheduling second downlink data messages at 1016) may be used to trigger type III HARQ-ACK codebook transmission for the second cell group. For example, at least one of the first downlink control messages and/or one of the second downlink control messages may include a one-shot feedback request field used to trigger UE 1004 to send the second feedback. Further, in certain aspects, at least one of the first downlink control messages and/or one of the second downlink control messages may include an enhanced type III HARQ-ACK codebook indicator field that indicates, for the second feedback, one or more enhanced type III HARQ-ACK codebooks to send for the second feedback.

In certain aspects where one or more enhanced type III HARQ-ACK codebooks are indicated to be transmitted, a restriction may be added such that different enhanced type III HARQ-ACK codebooks that are sent for the second cell group each have the same size. In certain aspects, this may cause the payload size of the type III HARQ-ACK codebook-based feedback to be fixed. The fixed codebook size may enable scheduling of the uplink transmission in the PCell for the first cell group, as well as allow for decoding of the HARQ-ACK feedback by network entity 1002, irrespective of the second cell group's decision.

Accordingly, in certain aspects per above, first downlink control message(s) associated with the first cell group (e.g., sent to UE 1004 at 1010 and scheduling first downlink data message(s) at 1012) (e.g., “DL DCI(s)” for the first cell group) may include two sets of fields for triggering type III HARQ-ACK codebook transmission for the first and second cell groups, respectively. In certain other aspects per above, the first downlink control message(s) may include one set of fields for triggering type III HARQ-ACK codebook transmission for the first cell group.

Further, in certain aspects per above, second downlink control message(s) associated with the second cell group (e.g., sent to UE 1004 at 1014 and scheduling second downlink data message(s) at 101) (e.g., “DL DCI(s)” for the second cell group) may not include any sets of fields for triggering type III HARQ-ACK codebook transmission for the first and second cell groups, respectively (e.g., no sets of fields for the first cell group and no sets of fields for the second cell group). In certain other aspects per above, the second downlink control message(s) may include one set of fields for triggering type III HARQ-ACK codebook transmission for the second cell group.

This HARQ-ACK codebook type combination may be different than single type III HARQ-ACK codebook construction and transmission for both cell groups with respect to DCI fields and triggering of the type III HARQ-ACK codebook-based feedback.

Note that the process flow illustrated in FIG. 10 is described herein to facilitate an understanding of HARQ-ACK codebook construction and transmission in a loose carrier aggregation implementation, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Operations of a User Equipment

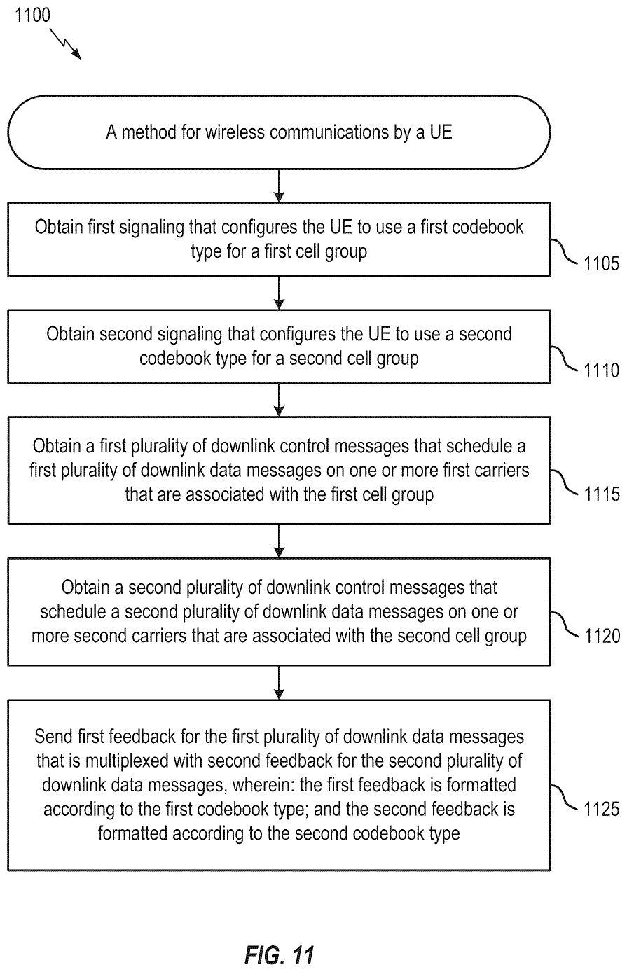

FIG. 11 shows a method 1100 for wireless communications by an apparatus, such as UE 104 of FIG. 1 or UE 304 of FIG. 3.

Method 1100 begins at block 1105 with obtaining first signaling that configures the UE to use a first codebook type for a first cell group.

Method 1100 then proceeds to block 1110 with obtaining second signaling that configures the UE to use a second codebook type for a second cell group.

Method 1100 then proceeds to block 1115 with obtaining a first plurality of downlink control messages that schedule a first plurality of downlink data messages on one or more first carriers that are associated with the first cell group.

Method 1100 then proceeds to block 1120 with obtaining a second plurality of downlink control messages that schedule a second plurality of downlink data messages on one or more second carriers that are associated with the second cell group.

Method 1100 then proceeds to block 1125 with sending first feedback for the first plurality of downlink data messages that is multiplexed with second feedback for the second plurality of downlink data messages, wherein: the first feedback is formatted according to the first codebook type; and the second feedback is formatted according to the second codebook type.

In some aspects, block 1125 includes sending the first feedback multiplexed with the second feedback via: an uplink control message scheduled in a first cell of the first cell group; a first uplink data message scheduled in the first cell of the first cell group; or a second uplink data message scheduled in a second cell of the second cell group.

In some aspects, each downlink control message of the first plurality of downlink control messages comprises a cDAI field for the first cell group.

In some aspects, the first cell group comprises more than one carrier; and each downlink control message of the first plurality of downlink control messages comprises a tDAI field for the first cell group.

In some aspects, each downlink control message of the second plurality of downlink control messages does not comprise a cDAI field and does not comprise a tDAI field for the second cell group.

In some aspects, method 1100 further includes obtaining a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message, wherein the first downlink control message comprises a first tDAI field for the first cell group.

In some aspects, the first downlink control message further comprises a second tDAI field that indicates to multiplex the second feedback with the first feedback for transmission via the first uplink data message or the second uplink data message; and block 1125 includes sending the first feedback multiplexed with the second feedback via the first uplink data message or the second uplink data message.

In some aspects, method 1100 further includes obtaining a first downlink control message that schedules an uplink data message in a second cell of the second cell group, wherein the first downlink control message does not comprise a first tDAI field for the first cell group and does not comprise a second tDAI field for the second cell group, and wherein block 1125 includes sending the first feedback multiplexed with the second feedback via an uplink control message scheduled in a first cell of the first cell group.

In some aspects, each downlink control message of the first plurality of downlink control messages does not comprise a cDAI field and does not comprise a tDAI field for the first cell group.

In some aspects, method 1100 further includes obtaining a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message, wherein the first downlink control message comprises a tDAI field that indicates to multiplex the first feedback with the second feedback for transmission via the first uplink data message of the second uplink data message, and wherein block 1125 includes sending the first feedback multiplexed with the second feedback via the first uplink data message or the second uplink data message.

In some aspects, method 1100 further includes obtaining a first downlink control message that schedules an uplink data message in a second cell of the second cell group, wherein the first downlink control message does not comprise a tDAI field that indicates to multiplex the first feedback with the second feedback, and wherein block 1125 includes sending the first feedback multiplexed with the second feedback via an uplink control message in a first cell of the first cell group.

In some aspects, at least one of a first downlink control message of the first plurality of downlink control messages or a second downlink control message of the second plurality of downlink control messages comprises a one-shot feedback request field that indicates, to the UE, to send the first feedback or the second feedback for the second plurality of downlink data messages.

In some aspects, the first signaling configures the UE to use a first plurality of enhanced type III HARQ ACK codebooks or the second signaling configures the UE to use the first plurality of enhanced type III HARQ ACK codebooks, at least one of the first codebook type and the second codebook type comprising one of the first plurality of enhanced type III HARQ ACK codebooks; and at least one of the first downlink control message or the second downlink control message comprises an enhanced type III HARQ ACK codebook indicator field that indicates, for the first feedback or the second feedback, one or more enhanced type III HARQ ACK codebooks of the first plurality of enhanced type III HARQ ACK codebooks.

In some aspects, the second codebook type comprises a type I HARQ ACK codebook or a type III HARQ ACK codebook.

In some aspects, the first codebook type comprises a type II HARQ ACK codebook; and the second codebook type comprises a type I HARQ ACK codebook.

In some aspects, the first codebook type comprises a type II HARQ ACK codebook; and the second codebook type comprises a type III HARQ ACK codebook.

In some aspects, the first codebook type comprises a type I HARQ ACK codebook; and the second codebook type comprises a type III HARQ ACK codebook.

In some aspects, the first codebook type comprises a type III HARQ ACK codebook; and the second codebook type comprises a type I HARQ ACK codebook.

In some aspects, the first codebook type comprises a type III HARQ ACK codebook; and the second codebook type comprises the type III HARQ ACK codebook.

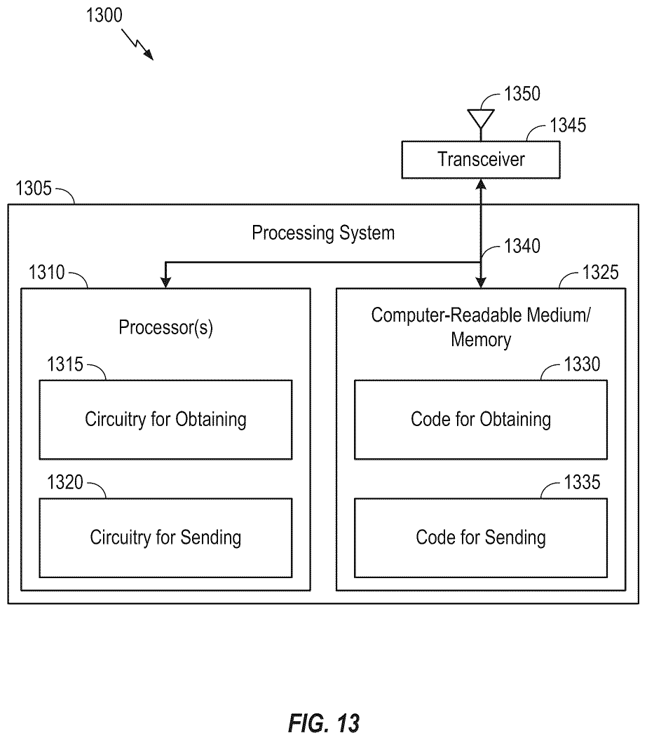

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure

### Example Operations of a Network Entity

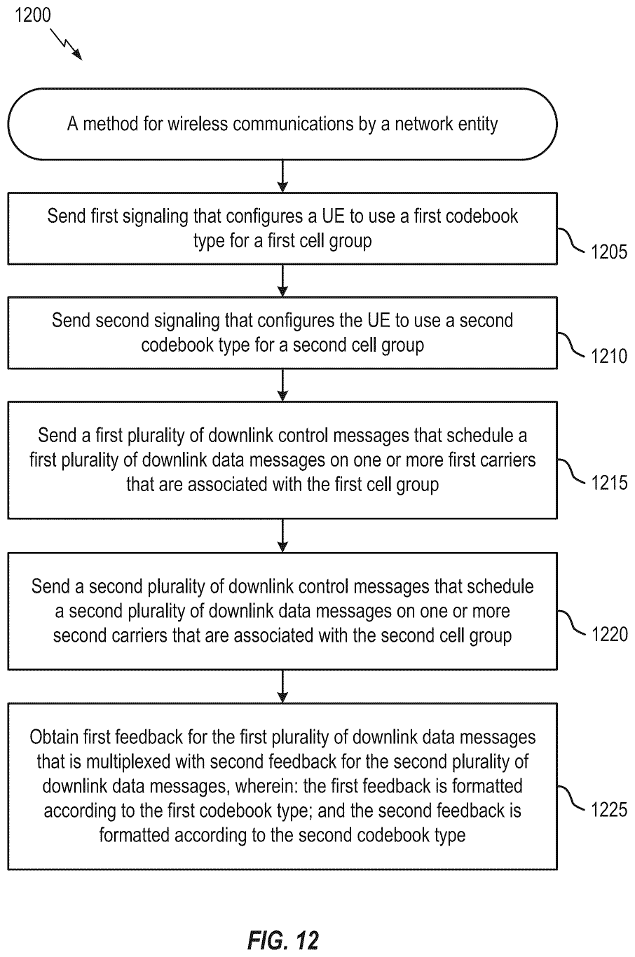

FIG. 12 shows a method 1200 for wireless communications by an apparatus, such as BS 102 of FIG. 1, a first network entity 300 or second network entity 302 of FIG.
3, or a disaggregated base station as discussed with respect to FIG. 2.

Method 1200 begins at block 1205 with sending first signaling that configures a UE to use a first codebook type for a first cell group.

Method 1200 then proceeds to block 1210 with sending second signaling that configures the UE to use a second codebook type for a second cell group.

Method 1200 then proceeds to block 1215 with sending a first plurality of downlink control messages that schedule a first plurality of downlink data messages on one or more first carriers that are associated with the first cell group.

Method 1200 then proceeds to block 1220 with sending a second plurality of downlink control messages that schedule a second plurality of downlink data messages on one or more second carriers that are associated with the second cell group.

Method 1200 then proceeds to block 1225 with obtaining first feedback for the first plurality of downlink data messages that is multiplexed with second feedback for the second plurality of downlink data messages, wherein: the first feedback is formatted according to the first codebook type; and the second feedback is formatted according to the second codebook type.

In some aspects, block 1225 includes obtaining the first feedback multiplexed with the second feedback via: an uplink control message scheduled in a first cell of the first cell group; a first uplink data message scheduled in the first cell of the first cell group; or a second uplink data message scheduled in a second cell of the second cell group.

In some aspects, each downlink control message of the first plurality of downlink control messages comprises a cDAI field for the first cell group.

In some aspects, the first cell group comprises more than one carrier; and each downlink control message of the first plurality of downlink control messages comprises a tDAI field for the first cell group.

In some aspects, each downlink control message of the second plurality of downlink control messages does not comprise a cDAI field and does not comprise a tDAI field for the second cell group.

In certain aspects, method 1200 further includes sending a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message; and the first downlink control message comprises a first tDAI field for the first cell group.

In some aspects, the first downlink control message further comprises a second tDAI field that indicates to multiplex the second feedback with the first feedback for transmission via the first uplink data message or the second uplink data message; and block 1225 includes obtaining the first feedback multiplexed with the second feedback via the first uplink data message or the second uplink data message.

In certain aspects, method 1200 further includes sending a first downlink control message that schedules an uplink data message in a second cell of the second cell group, wherein the first downlink control message does not comprise a first tDAI field for the first cell group and does not comprise a second tDAI field for the second cell group, and wherein block 1225 includes obtaining the first feedback multiplexed with the second feedback via an uplink control message scheduled in a first cell of the first cell group.

In some aspects, each downlink control message of the first plurality of downlink control messages does not comprise a cDAI field and does not comprise a tDAI field for the first cell group.

In certain aspects, method 1200 further includes sending a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message, wherein the first downlink control message comprises a tDAI field that indicates to multiplex the first feedback with the second feedback for transmission via the first uplink data message of the second uplink data message, and wherein block 1225 includes obtaining the first feedback multiplexed with the second feedback via the first uplink data message or the second uplink data message.

In certain aspects, method 1200 further includes sending a first downlink control message that schedules an uplink data message in a second cell of the second cell group, wherein the first downlink control message does not comprise a tDAI field that indicates to multiplex the first feedback with the second feedback, and wherein block 1225 includes obtaining the first feedback multiplexed with the second feedback via an uplink control message in a first cell of the first cell group.

In some aspects, at least one of a first downlink control message of the first plurality of downlink control messages or a second downlink control message of the second plurality of downlink control messages comprises a one-shot feedback request field that indicates, to the UE, to send the first feedback or the second feedback for the second plurality of downlink data messages.

In some aspects, the first signaling configures the UE to use a first plurality of enhanced type III HARQ ACK codebooks or the second signaling configures the UE to use the first plurality of enhanced type III HARQ ACK codebooks, at least one of the first codebook type and the second codebook type comprising one of the first plurality of enhanced type III HARQ ACK codebooks; and at least one of the first downlink control message or the second downlink control message comprises an enhanced type III HARQ ACK codebook indicator field that indicates, for the first feedback or the second feedback, one or more enhanced type III HARQ ACK codebooks of the first plurality of enhanced type III HARQ ACK codebooks.

In some aspects, the second codebook type comprises a type I HARQ ACK codebook or a type III HARQ ACK codebook.

In some aspects, the first codebook type comprises a type II HARQ ACK codebook; and the second codebook type comprises a type I HARQ ACK codebook.

In some aspects, the first codebook type comprises a type II HARQ ACK codebook; and the second codebook type comprises a type III HARQ ACK codebook.

In some aspects, the first codebook type comprises a type I HARQ ACK codebook; and the second codebook type comprises a type III HARQ ACK codebook.

In some aspects, the first codebook type comprises a type III HARQ ACK codebook; and the second codebook type comprises a type I HARQ ACK codebook.

In some aspects, the first codebook type comprises a type III HARQ ACK codebook; and the second codebook type comprises the type III HARQ ACK codebook.

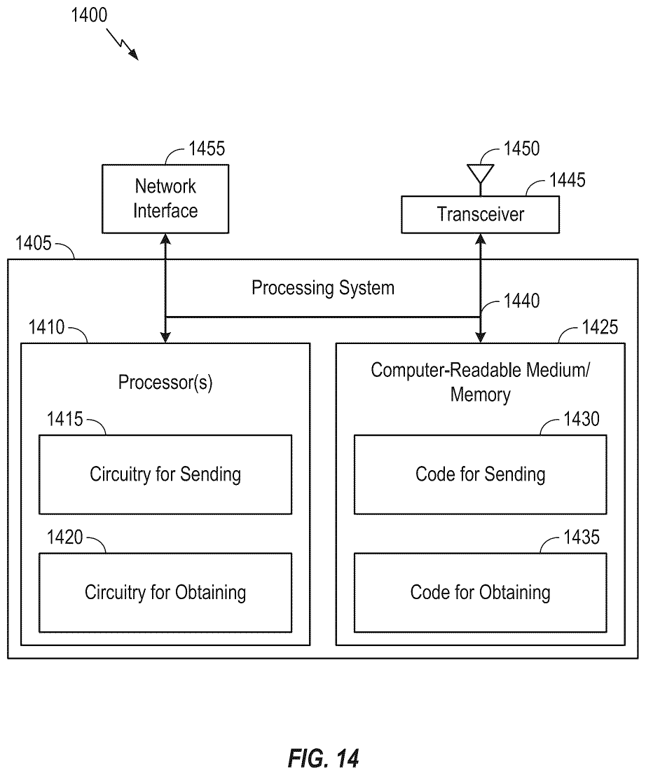

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for obtaining 1330 and code for sending 1335. Processing of the may enable and cause the communications device 1300 to perform the method 1100 described with respect to FIG. 11, or any aspect related to it. For instance, in some aspects, code for obtaining 1330 includes code for obtaining first signaling that configures the UE to use a first codebook type for a first cell group. In some aspects, code for obtaining 1330 includes code for obtaining second signaling that configures the UE to use a second codebook type for a second cell group. In some aspects, code for obtaining 1330 includes code for obtaining a first plurality of downlink control messages that schedule a first plurality of downlink data messages on one or more first carriers that are associated with the first cell group. In some aspects, code for obtaining 1330 includes code for obtaining a second plurality of downlink control messages that schedule a second plurality of downlink data messages on one or more second carriers that are associated with the second cell group. In some aspects, code for sending 1335 includes code for sending first feedback for the first plurality of downlink data messages that is multiplexed with second feedback for the second plurality of downlink data messages, wherein: the first feedback is formatted according to the first codebook type; and the second feedback is formatted according to the second codebook type.

The one or more processors 1310 include circuitry configured to implement (e.g., execute) the code stored in the computer-readable medium/memory 1325, including circuitry for obtaining 1315 and circuitry for sending 1320. Processing with circuitry for obtaining 1315 and circuitry for sending 1320 may enable and cause the communications device 1300 to perform the method 1100 described with respect to FIG. 11, or any aspect related to it. For instance, in some aspects, circuitry for obtaining 1315 includes circuitry for obtaining first signaling that configures the UE to use a first codebook type for a first cell group. In some aspects, circuitry for obtaining 1315 includes circuitry for obtaining second signaling that configures the UE to use a second codebook type for a second cell group. In some aspects, circuitry for obtaining 1315 includes circuitry for obtaining a first plurality of downlink control messages that schedule a first plurality of downlink data messages on one or more first carriers that are associated with the first cell group. In some aspects, circuitry for obtaining 1315 includes circuitry for obtaining a second plurality of downlink control messages that schedule a second plurality of downlink data messages on one or more second carriers that are associated with the second cell group. In some aspects, circuitry for sending 1320 includes circuitry for sending first feedback for the first plurality of downlink data messages that is multiplexed with second feedback for the second plurality of downlink data messages, wherein: the first feedback is formatted according to the first codebook type; and the second feedback is formatted according to the second codebook type.

More generally, means for communicating, transmitting, sending or outputting for transmission may include the one or more transceivers 324, one or more antenna 322 and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code for sending 1430 and code for obtaining 1435, that when executed by the one or more processors 1410, cause the one or more processors 1410 to perform the method 1200 described with respect to FIG. 12, or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for sending 1430 and code for obtaining 1435. Processing of the code for sending 1430 and code for obtaining 1435 may enable and cause the communications device 1400 to perform the method 1200 described with respect to FIG. 12, or any aspect related to it. For instance, in some aspects, code for sending 1430 includes code for sending first signaling that configures a UE to use a first codebook type for a first cell group. In some aspects, code for sending 1430 includes code for sending second signaling that configures the UE to use a second codebook type for a second cell group. In some aspects, code for sending 1430 includes code for sending a first plurality of downlink control messages that schedule a first plurality of downlink data messages on one or more first carriers that are associated with the first cell group. In some aspects, code for sending 1430 includes code for sending a second plurality of downlink control messages that schedule a second plurality of downlink data messages on one or more second carriers that are associated with the second cell group. In some aspects, code for obtaining 1435 includes code for obtaining first feedback for the first plurality of downlink data messages that is multiplexed with second feedback for the second plurality of downlink data messages, wherein: the first feedback is formatted according to the first codebook type; and the second feedback is formatted according to the second codebook type.

The one or more processors 1410 include circuitry configured to implement (e.g., execute) the code stored in the computer-readable medium/memory 1425, including circuitry for sending 1415 and circuitry for obtaining 1420. Processing with circuitry for sending 1415 and circuitry for obtaining 1420 may enable and cause the communications device 1400 to perform the method 1200 described with respect to FIG. 12, or any aspect related to it. For instance, in some aspects, circuitry for sending 1415 includes circuitry for sending first signaling that configures a UE to use a first codebook type for a first cell group. In some aspects, circuitry for sending 1415 includes circuitry for sending second signaling that configures the UE to use a second codebook type for a second cell group. In some aspects, circuitry for sending 1415 includes circuitry for sending a first plurality of downlink control messages that schedule a first plurality of downlink data messages on one or more first carriers that are associated with the first cell group. In some aspects, circuitry for sending 1415 includes circuitry for sending a second plurality of downlink control messages that schedule a second plurality of downlink data messages on one or more second carriers that are associated with the second cell group. In some aspects, circuitry for obtaining 1420 includes circuitry for obtaining first feedback for the first plurality of downlink data messages that is multiplexed with second feedback for the second plurality of downlink data messages, wherein: the first feedback is formatted according to the first codebook type; and the second feedback is formatted according to the second codebook type.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

### Example Clauses

Implementation examples are described in the following numbered clauses:
Clause 1: A method for wireless communications by a UE comprising: obtaining first signaling that configures the UE to use a first codebook type for a first cell group; obtaining second signaling that configures the UE to use a second codebook type for a second cell group; obtaining a first plurality of downlink control messages that schedule a first plurality of downlink data messages on one or more first carriers that are associated with the first cell group; obtaining a second plurality of downlink control messages that schedule a second plurality of downlink data messages on one or more second carriers that are associated with the second cell group; and sending first feedback for the first plurality of downlink data messages that is multiplexed with second feedback for the second plurality of downlink data messages, wherein: the first feedback is formatted according to the first codebook type; and the second feedback is formatted according to the second codebook type.
Clause 2: The method of Clause 1, wherein sending the first feedback multiplexed with the second feedback comprises sending the first feedback multiplexed with the second feedback via: an uplink control message scheduled in a first cell of the first cell group; a first uplink data message scheduled in the first cell of the first cell group; or a second uplink data message scheduled in a second cell of the second cell group.
Clause 3: The method of any one of Clauses 1-2, wherein: each downlink control message of the first plurality of downlink control messages comprises a cDAI field for the first cell group.
Clause 4: The method of Clause 3, wherein: the first cell group comprises more than one carrier; and each downlink control message of the first plurality of downlink control messages comprises a tDAI field for the first cell group.
Clause 5: The method of any one of Clauses 1-4, wherein: each downlink control message of the second plurality of downlink control messages does not comprise a cDAI field and does not comprise a tDAI field for the second cell group.
Clause 6: The method of any one of Clauses 1-5, further comprising: obtaining a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message; wherein the first downlink control message comprises a first tDAI field for the first cell group.
Clause 7: The method of Clause 6, wherein: the first downlink control message further comprises a second tDAI field that indicates to multiplex the second feedback with the first feedback for transmission via the first uplink data message or the second uplink data message; and sending the first feedback multiplexed with the second feedback comprises sending the first feedback multiplexed with the second feedback via the first uplink data message or the second uplink data message.
Clause 8: The method of any one of Clauses 1-7, further comprising: obtaining a first downlink control message that schedules an uplink data message in a second cell of the second cell group; wherein the first downlink control message does not comprise a first tDAI field for the first cell group and does not comprise a second tDAI field for the second cell group; and wherein sending the first feedback multiplexed with the second feedback comprises sending the first feedback multiplexed with the second feedback via an uplink control message scheduled in a first cell of the first cell group.
Clause 9: The method of any one of Clauses 1-8, wherein: each downlink control message of the first plurality of downlink control messages does not comprise a cDAI field and does not comprise a tDAI field for the first cell group.
Clause 10: The method of any one of Clauses 1-9, further comprising: obtaining a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message; wherein the first downlink control message comprises a tDAI field that indicates to multiplex the first feedback with the second feedback for transmission via the first uplink data message of the second uplink data message; and wherein sending the first feedback multiplexed with the second feedback comprises sending the first feedback multiplexed with the second feedback via the first uplink data message or the second uplink data message.
Clause 11: The method of any one of Clauses 1-10, further comprising: obtaining a first downlink control message that schedules an uplink data message in a second cell of the second cell group; wherein the first downlink control message does not comprise a tDAI field that indicates to multiplex the first feedback with the second feedback; and wherein sending the first feedback multiplexed with the second feedback comprises sending the first feedback multiplexed with the second feedback via an uplink control message in a first cell of the first cell group.
Clause 12: The method of any one of Clauses 1-11, wherein: at least one of a first downlink control message of the first plurality of downlink control messages or a second downlink control message of the second plurality of downlink control messages comprises a one-shot feedback request field that indicates, to the UE, to send the first feedback or the second feedback for the second plurality of downlink data messages.
Clause 13: The method of Clause 12, wherein: the first signaling configures the UE to use a first plurality of enhanced type III HARQ ACK codebooks or the second signaling configures the UE to use the first plurality of enhanced type III HARQ ACK codebooks, at least one of the first codebook type and the second codebook type comprising one of the first plurality of enhanced type III HARQ ACK codebooks; and at least one of the first downlink control message or the second downlink control message comprises an enhanced type III HARQ ACK codebook indicator field that indicates, for the first feedback or the second feedback, one or more enhanced type III HARQ ACK codebooks of the first plurality of enhanced type III HARQ ACK codebooks.
Clause 14: The method of any one of Clauses 1-13, wherein: the second codebook type comprises a type I HARQ ACK codebook or a type III HARQ ACK codebook.
Clause 15: The method of any one of Clauses 1-14, wherein: the first codebook type comprises a type II HARQ ACK codebook; and the second codebook type comprises a type I HARQ ACK codebook.
Clause 16: The method of any one of Clauses 1-15, wherein: the first codebook type comprises a type II HARQ ACK codebook; and the second codebook type comprises a type III HARQ ACK codebook.
Clause 17: The method of any one of Clauses 1-16, wherein: the first codebook type comprises a type I HARQ ACK codebook; and the second codebook type comprises a type III HARQ ACK codebook.
Clause 18: The method of any one of Clauses 1-17, wherein: the first codebook type comprises a type III HARQ ACK codebook; and the second codebook type comprises a type I HARQ ACK codebook.
Clause 19: The method of any one of Clauses 1-18, wherein: the first codebook type comprises a type III HARQ ACK codebook; and the second codebook type comprises the type III HARQ ACK codebook.
Clause 20: A method for wireless communications by a network entity comprising: sending first signaling that configures a UE to use a first codebook type for a first cell group; sending second signaling that configures the UE to use a second codebook type for a second cell group; sending a first plurality of downlink control messages that schedule a first plurality of downlink data messages on one or more first carriers that are associated with the first cell group; sending a second plurality of downlink control messages that schedule a second plurality of downlink data messages on one or more second carriers that are associated with the second cell group; and obtaining first feedback for the first plurality of downlink data messages that is multiplexed with second feedback for the second plurality of downlink data messages, wherein: the first feedback is formatted according to the first codebook type; and the second feedback is formatted according to the second codebook type.
Clause 21: The method of Clause 20, wherein obtaining the first feedback multiplexed with the second feedback comprises obtaining the first feedback multiplexed with the second feedback via: an uplink control message scheduled in a first cell of the first cell group; a first uplink data message scheduled in the first cell of the first cell group; or a second uplink data message scheduled in a second cell of the second cell group.
Clause 22: The method of any one of Clauses 20-21, wherein: each downlink control message of the first plurality of downlink control messages comprises a cDAI field for the first cell group.
Clause 23: The method of Clause 22, wherein: the first cell group comprises more than one carrier; and each downlink control message of the first plurality of downlink control messages comprises a tDAI field for the first cell group.
Clause 24: The method of any one of Clauses 20-23, wherein: each downlink control message of the second plurality of downlink control messages does not comprise a cDAI field and does not comprise a tDAI field for the second cell group.
Clause 25: The method of any one of Clauses 20-24, further comprising sending a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message; and the first downlink control message comprises a first tDAI field for the first cell group.
Clause 26: The method of Clause 25, wherein: the first downlink control message further comprises a second tDAI field that indicates to multiplex the second feedback with the first feedback for transmission via the first uplink data message or the second uplink data message; and obtaining the first feedback multiplexed with the second feedback comprises obtaining the first feedback multiplexed with the second feedback via the first uplink data message or the second uplink data message.
Clause 27: The method of any one of Clauses 20-26, further comprising: sending a first downlink control message that schedules an uplink data message in a second cell of the second cell group; wherein the first downlink control message does not comprise a first tDAI field for the first cell group and does not comprise a second tDAI field for the second cell group; and wherein obtaining the first feedback multiplexed with the second feedback comprises obtaining the first feedback multiplexed with the second feedback via an uplink control message scheduled in a first cell of the first cell group.
Clause 28: The method of any one of Clauses 20-27, wherein: each downlink control message of the first plurality of downlink control messages does not comprise a cDAI field and does not comprise a tDAI field for the first cell group.
Clause 29: The method of any one of Clauses 20-28, further comprising: sending a first downlink control message that schedules: a first uplink data message in a first cell of the first cell group, the first uplink data message overlapping, in a time domain, an uplink control message scheduled in the first cell of the first cell group; or a second uplink data message in a second cell of the second cell group, the second uplink data message overlapping, in the time domain, the uplink control message; wherein the first downlink control message comprises a tDAI field that indicates to multiplex the first feedback with the second feedback for transmission via the first uplink data message of the second uplink data message; and wherein obtaining the first feedback multiplexed with the second feedback comprises obtaining the first feedback multiplexed with the second feedback via the first uplink data message or the second uplink data message.
Clause 30: The method of any one of Clauses 20-29, further comprising: sending a first downlink control message that schedules an uplink data message in a second cell of the second cell group; wherein the first downlink control message does not comprise a tDAI field that indicates to multiplex the first feedback with the second feedback; and wherein obtaining the first feedback multiplexed with the second feedback comprises obtaining the first feedback multiplexed with the second feedback via an uplink control message in a first cell of the first cell group.
Clause 31: The method of any one of Clauses 20-30, wherein: at least one of a first downlink control message of the first plurality of downlink control messages or a second downlink control message of the second plurality of downlink control messages comprises a one-shot feedback request field that indicates, to the UE, to send the first feedback or the second feedback for the second plurality of downlink data messages.
Clause 32: The method of Clause 31, wherein: the first signaling configures the UE to use a first plurality of enhanced type III HARQ ACK codebooks or the second signaling configures the UE to use the first plurality of enhanced type III HARQ ACK codebooks, at least one of the first codebook type and the second codebook type comprising one of the first plurality of enhanced type III HARQ ACK codebooks; and at least one of the first downlink control message or the second downlink control message comprises an enhanced type III HARQ ACK codebook indicator field that indicates, for the first feedback or the second feedback, one or more enhanced type III HARQ ACK codebooks of the first plurality of enhanced type III HARQ ACK codebooks.
Clause 33: The method of any one of Clauses 20-32, wherein: the second codebook type comprises a type I HARQ ACK codebook or a type III HARQ ACK codebook.
Clause 34: The method of any one of Clauses 20-33, wherein: the first codebook type comprises a type II HARQ ACK codebook; and the second codebook type comprises a type I HARQ ACK codebook.
Clause 35: The method of any one of Clauses 20-34, wherein: the first codebook type comprises a type II HARQ ACK codebook; and the second codebook type comprises a type III HARQ ACK codebook.
Clause 36: The method of any one of Clauses 20-35, wherein: the first codebook type comprises a type I HARQ ACK codebook; and the second codebook type comprises a type III HARQ ACK codebook.
Clause 37: The method of any one of Clauses 20-36, wherein: the first codebook type comprises a type III HARQ ACK codebook; and the second codebook type comprises a type I HARQ ACK codebook.
Clause 38: The method of any one of Clauses 20-37, wherein: the first codebook type comprises a type III HARQ ACK codebook; and the second codebook type comprises the type III HARQ ACK codebook.
Clause 39: One or more apparatuses, comprising: one or more memories comprising executable instructions; and one or more processors configured to execute the executable instructions and cause the one or more apparatuses to perform a method in accordance with any one of Clauses 1-38.
Clause 40: One or more apparatuses configured for wireless communications, comprising: one or more memories; and one or more processors, coupled to the one or more memories, configured to cause the one or more apparatuses to perform a method in accordance with any one of Clauses 1-38.
Clause 41: One or more apparatuses configured for wireless communications, comprising: one or more memories; and one or more processors, coupled to the one or more memories, configured to perform a method in accordance with any one of Clauses 1-38.
Clause 42: One or more apparatuses, comprising means for performing a method in accordance with any one of Clauses 1-38.
Clause 43: One or more non-transitory computer-readable media comprising executable instructions that, when executed by one or more processors of one or more apparatuses, cause the one or more apparatuses to perform a method in accordance with any one of Clauses 1-38.
Clause 44: One or more computer program products embodied on one or more computer-readable storage media comprising code for performing a method in accordance with any one of Clauses 1-38.
Clause 45: One or more apparatuses configured for wireless communications, comprising: a processing system that includes one or more processors and one or more memories coupled with the one or more processors, the processing system configured to cause the one or more apparatuses to perform a method in accordance with any one of Clauses 1-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain first signaling that configures the UE to use a first codebook type for a first cell group;
obtain second signaling that configures the UE to use a second codebook type for a second cell group;
obtain a first plurality of downlink control messages that schedule a first plurality of downlink data messages on one or more first carriers that are associated with the first cell group;
obtain a second plurality of downlink control messages that schedule a second plurality of downlink data messages on one or more second carriers that are associated with the second cell group; and
send first feedback for the first plurality of downlink data messages that is multiplexed with second feedback for the second plurality of downlink data messages, wherein:
the first feedback is formatted according to the first codebook type; and
the second feedback is formatted according to the second codebook type.

2. The apparatus of claim 1, wherein to cause the UE to send the first feedback multiplexed with the second feedback, the processing system is configured to cause the UE to send the first feedback multiplexed with the second feedback via:
an uplink control message scheduled in a first cell of the first cell group;
a first uplink data message scheduled in the first cell of the first cell group; or
a second uplink data message scheduled in a second cell of the second cell group.

3. The apparatus of claim 1, wherein:
each downlink control message of the first plurality of downlink control messages comprises a counter downlink assignment index (DAI) (cDAI) field for the first cell group.

4. The apparatus of claim 3, wherein:
the first cell group comprises more than one carrier; and
each downlink control message of the first plurality of downlink control messages comprises a total DAI (tDAI) field for the first cell group.

5. The apparatus of claim 1, wherein:
each downlink control message of the second plurality of downlink control messages does not comprise a counter downlink assignment index (DAI) (cDAI) field and does not comprise a total DAI (tDAI) field for the second cell group.

6. The apparatus of claim 1, wherein:
the processing system is configured to cause the UE to obtain a first downlink control message that schedules:
a first uplink data message in a first cell of the first cell group, the first uplink data message overlapping, in a time domain, an uplink control message scheduled in the first cell of the first cell group; or
a second uplink data message in a second cell of the second cell group, the second uplink data message overlapping, in the time domain, the uplink control message; and
the first downlink control message comprises a first total downlink assignment index (DAI) (tDAI) field for the first cell group.

7. The apparatus of claim 6, wherein:
the first downlink control message further comprises a second tDAI field that indicates to multiplex the second feedback with the first feedback for transmission via the first uplink data message or the second uplink data message; and
to cause the UE to send the first feedback multiplexed with the second feedback, the processing system is configured to cause the UE to send the first feedback multiplexed with the second feedback via the first uplink data message or the second uplink data message.

8. The apparatus of claim 1, wherein:
the processing system is configured to cause the UE to obtain a first downlink control message that schedules an uplink data message in a second cell of the second cell group;
the first downlink control message does not comprise a first total downlink assignment index (DAI) (tDAI) field for the first cell group and does not comprise a second tDAI field for the second cell group; and
to cause the UE to send the first feedback multiplexed with the second feedback, the processing system is configured to cause the UE to send the first feedback multiplexed with the second feedback via an uplink control message scheduled in a first cell of the first cell group.

9. The apparatus of claim 1, wherein:
each downlink control message of the first plurality of downlink control messages does not comprise a counter downlink assignment index (DAI) (cDAI) field and does not comprise a total DAI (tDAI) field for the first cell group.

10. The apparatus of claim 1, wherein:
the processing system is configured to cause the UE to obtain a first downlink control message that schedules:
a first uplink data message in a first cell of the first cell group, the first uplink data message overlapping, in a time domain, an uplink control message scheduled in the first cell of the first cell group; or
a second uplink data message in a second cell of the second cell group, the second uplink data message overlapping, in the time domain, the uplink control message;
the first downlink control message comprises a total downlink assignment index (DAI) (tDAI) field that indicates to multiplex the first feedback with the second feedback for transmission via the first uplink data message of the second uplink data message; and
to cause the UE to send the first feedback multiplexed with the second feedback, the processing system is configured to cause the UE to send the first feedback multiplexed with the second feedback via the first uplink data message or the second uplink data message.

11. The apparatus of claim 1, wherein:
the processing system is configured to cause the UE to obtain a first downlink control message that schedules an uplink data message in a second cell of the second cell group;
the first downlink control message does not comprise a total downlink assignment index (DAI) (tDAI) field that indicates to multiplex the first feedback with the second feedback; and
to cause the UE to send the first feedback multiplexed with the second feedback, the processing system is configured to cause the UE to send the first feedback multiplexed with the second feedback via an uplink control message in a first cell of the first cell group.

12. The apparatus of claim 1, wherein:
at least one of a first downlink control message of the first plurality of downlink control messages or a second downlink control message of the second plurality of downlink control messages comprises a one-shot feedback request field that indicates, to the UE, to send the first feedback or the second feedback for the second plurality of downlink data messages.

13. The apparatus of claim 12, wherein:
the first signaling configures the UE to use a first plurality of enhanced type III HARQ-ACK codebooks or the second signaling configures the UE to use the first plurality of enhanced type III HARQ-ACK codebooks, at least one of the first codebook type and the second codebook type comprising one of the first plurality of enhanced type III HARQ-ACK codebooks; and
at least one of the first downlink control message or the second downlink control message comprises an enhanced type III HARQ-ACK codebook indicator field that indicates, for the first feedback or the second feedback, one or more enhanced type III HARQ-ACK codebooks of the first plurality of enhanced type III HARQ-ACK codebooks.

14. The apparatus of claim 1, wherein:
the first codebook type comprises a type II hybrid automatic repeat request (HARQ) acknowledgement (ACK) codebook; and
the second codebook type comprises a type I HARQ-ACK codebook.

15. The apparatus of claim 1, wherein:
the first codebook type comprises a type II hybrid automatic repeat request (HARQ) acknowledgement (ACK) codebook; and
the second codebook type comprises a type III HARQ-ACK codebook.

16. The apparatus of claim 1, wherein:
the first codebook type comprises a type I hybrid automatic repeat request (HARQ) acknowledgement (ACK) codebook; and
the second codebook type comprises a type III HARQ-ACK codebook.

17. The apparatus of claim 1, wherein:
the first codebook type comprises a type III hybrid automatic repeat request (HARQ) acknowledgement (ACK) codebook; and
the second codebook type comprises a type I HARQ-ACK codebook.

18. The apparatus of claim 1, wherein:
the first codebook type comprises a type III hybrid automatic repeat request (HARQ) acknowledgement (ACK) codebook; and
the second codebook type comprises the type III HARQ-ACK codebook.

19. A method of wireless communications by a user equipment (UE), comprising:
obtaining first signaling that configures the UE to use a first codebook type for a first cell group;
obtaining second signaling that configures the UE to use a second codebook type for a second cell group;
obtaining a first plurality of downlink control messages that schedule a first plurality of downlink data messages on one or more first carriers that are associated with the first cell group;
obtaining a second plurality of downlink control messages that schedule a second plurality of downlink data messages on one or more second carriers that are associated with the second cell group; and
sending first feedback for the first plurality of downlink data messages that is multiplexed with second feedback for the second plurality of downlink data messages, wherein:
the first feedback is formatted according to the first codebook type; and
the second feedback is formatted according to the second codebook type.

20. One or more non-transitory computer-readable media comprising executable instructions that, when executed by one or more processors of an apparatus, cause a user equipment (UE) to perform operations comprising:
obtaining first signaling that configures the UE to use a first codebook type for a first cell group;
obtaining second signaling that configures the UE to use a second codebook type for a second cell group;
obtaining a first plurality of downlink control messages that schedule a first plurality of downlink data messages on one or more first carriers that are associated with the first cell group;
obtaining a second plurality of downlink control messages that schedule a second plurality of downlink data messages on one or more second carriers that are associated with the second cell group; and
sending first feedback for the first plurality of downlink data messages that is multiplexed with second feedback for the second plurality of downlink data messages, wherein:
the first feedback is formatted according to the first codebook type; and
the second feedback is formatted according to the second codebook type.
